(19) United States
(12) Patent Application Publication
(10) Pub. No.: US 2026/0233436 A1
(43) Pub. Date: Aug. 13, 2026

(54) CENTRIFUGALLY-MOLDED ARTICLES AND METHODS

(71) Applicant: Trustees of Tufts College, Medford, MA (US)

(72) Inventors: David L. Kaplan, Concord, MA (US); Glenn Leung, Fairhaven, MA (US); Vincent P. Fitzpatrick, Somerville, MA (US)

(21) Appl. No.: 19/431,258

(22) Filed: Dec. 23, 2025

Related U.S. Application Data
(63) Continuation of application No. PCT/US24/36403, filed on Jul. 1, 2024.
(60) Provisional application No. 63/511,572, filed on Jun. 30, 2023.

(51) Int. Cl. B29C 41/04; B29C 41/00; B29K 105/00

(52) U.S. Cl. CPC B29C 41/04; B29C 41/003; B29K 2089/00; B29K 2105/0073; B29K 2995/0056

(57) ABSTRACT

Centrifugal controlled biosolidification molding is disclosed. The methods involve use of aqueous solutions and centrifugal force in a unique processing method that produces highly uniform and useful articles from biopolymers that previously were formed by methods with significant shortcomings. In some cases, the technique uses a single biopolymer, which can produce highly uniform articles. In other cases, the technique uses different polymers, which can provide tailorable and tunable properties, such as desirable dissolution properties. Articles made by these methods overcome significant disadvantages from current techniques and exhibit a lack of external and internal layering and uniform bulk material.

### CROSS-REFERENCE TO RELATED APPLICATIONS

This application claims benefit of and is a continuation of International Patent Application No. PCT/US2024/036403 (Attorney Docket No. 2095.0612), filed Jul. 1, 2024, and entitled “CENTRIFUGALLY-MOLDED ARTICLES AND METHODS,” International Pub. No. WO 2025/007132, which is hereby incorporated by reference in its entirety for all purposes.

International Patent Application No. PCT/US2024/036403 relates to, incorporates by reference for all purposes, and claims priority to U.S. Provisional Patent Application 63/511,572 (Attorney Docket No. 2095.0519), filed Jun. 30, 2023.

### GOVERNMENT FUNDING STATEMENT

This invention was made with government support under P41EB027062 awarded by the National Institutes of Health. The government has certain rights in the invention.

### SEQUENCE LISTING

A Sequence Listing accompanies this application and is submitted as an XML file of the sequence listing named “T002694 WO-2095.0612.xml” which is 31,845 bytes in size and was created on Jun. 23, 2024. The sequence listing is electronically submitted with the application and is incorporated herein by reference in its entirety.

### BACKGROUND

Conventional silk processing techniques are capable of producing solid articles, but the current suite of techniques has shortcomings which results in articles having one or more undesirable properties.

More broadly, biopolymer and polymer processing techniques presently lack a method of making a biopolymer article with material robustness that approaches more conventional polymers.

Typical methods are limited by the diffusion of a polymerizing agent into the article. When an article reaches a certain size, the diffusion causes non-uniform crystallization.

One existing technique of making silk articles is thermal molding and/or compression molding of silk powders. This has a variety of shortcomings, including an inability to elastic, non-brittle mechanical features.

Another existing technique is silk fibroin-tailored injection molding. Distinct from traditional “melt-and-inject” processes, silk fibroin's aqueous injection molding process has traditionally produced materials that are insufficiently uniform and have a high degree of interior voids.

Yet another existing technique is three-dimensional printing. 3D printing using silk and biopolymers produces articles that have layered character and contain significant internal voids. In most cases, biopolymers are 3D printed using extrusion of cylinders of biopolymer, so there are large gaps between the cylinders of material.

A need exists for new methods and articles that overcome one or more of the aforementioned shortcomings.

### SUMMARY

Disclosed herein is a novel approach to molding biopolymers enabling the generation of complex geometries with high resolution, and centimeter-scale objects, using biopolymer solutions. This method rests on alternating deposition of material into a mold, centrifuging for shape conformity, and polymerizing the solution in situ. This process is repeated multiple times until the mold is filled, at which point the construct can be unmolded and polymerization can be finished.

In one aspect, the present disclosure provides a controlled centrifugal solidification biopolymer article.

In another aspect, the present disclosure provides a method of centrifugal controlled biosolidification molding. The method includes: A) introducing a first aqueous biopolymer solution into a mold and optionally settling the first aqueous biopolymer solution into the mold; B) introducing a first aqueous curing solution into the mold atop the first aqueous biopolymer solution and optionally settling the first aqueous curing solution into the mold, wherein the mold has a first orientation relative to gravity during step B); and C) subjecting the mold and contents of the mold to a first centrifugation and stopping after a first centrifugation length of time, thereby producing a first biosolidifying body, wherein the mold is within 45° of the first orientation relative to the first centrifugation during step C). Waiting a first final biosolidification length of time following step C) produces a first biopolymer article from the first biosolidifying body.

In yet another aspect, the present disclosure provides a method of making a biopolymer article. The method includes at least two iterative cycles of the following steps: X) introducing an iterative aqueous biopolymer solution into a mold and optionally settling the iterative aqueous biopolymer solution into the mold; Y) introducing an iterative aqueous curing solution into the mold atop the iterative aqueous biopolymer solution and optionally settling the iterative aqueous curing solution into the mold; and Z) subjecting the mold and the contents of the mold to an iterative centrifugation and stopping after an iterative centrifugal length of time, thereby iteratively adding to existing portions of the solidifying body, the iteratively introducing of step X), introducing of step Y), and subjecting of step Z) continuing until a final biosolidifying body is formed. Waiting a final biosolidification length of time following formation of the final biosolidification body produces the biopolymer article.

In yet another aspect, the present disclosure provides a method comprising: centrifuging a first early-stage-of-solidification aqueous biopolymer solution within a mold until a first later stage of solidification, thereby forming a first biosolidifying body.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 is a schematic representation of various aspects of the centrifugal methods disclosed herein.

FIG. 2 is a schematic representation of one aspect of loading solutions, in accordance with aspects of the present disclosure.

FIG. 3 is a pair of images showing a tubular article made by the disclosed methods.

FIG. 4 depicts a process for aqueous solvent directed centrifugal molding for biopolymer fabrication and enhancement.

### DETAILED DESCRIPTION

Before the present invention is described in further detail, it is to be understood that the invention is not limited to the particular embodiments described. It is also understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

Specific structures, devices, and methods relating to surface patterning are disclosed. It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

As used herein, a “film” refers to a layered structure having size dimensions that are not limited in two spatial dimensions and in a third spatial dimension has a thickness of between a monolayer and 2 mm or less than 2 mm, including but not limited to, a thickness of less than 1.5 mm, less than 1 mm, less than 0.5 mm, or less than 0.1 mm.

As used herein, “free of cylindrical extrusion gaps” refers to a lack of observable gaps within an article that are characteristic of a three-dimensional printing process that utilizes extruded cylinders of polymers.

As used herein, “free of layering” refers to a lack of observable layer structures within an article. Layering can be observed by imaging (e.g., scanning electron microscopy), spectroscopy (e.g., FTIR or fluorescence spectroscopy), or other analytical method (e.g., differential scanning calorimetry). Examples of techniques that do exhibit layering in their resulting products (i.e., these do not produce products that are free of layering, to the best of our understanding) are dip-coating (the separate coating layers can be distinctly identified) or three-dimensional printing (the printing process is typically a layered process that can be identified).

As used herein, “free of exterior layering” refers to an article being free of layering as observed from an exterior of the article.

As used herein, “free of interior layering” refers to an article being free of layering as observed internally within the article. In most cases, the absence of interior layering can be observed by cross-sectioning the article and assessing the newly-exposed face for evidence of layering. For example, an article may have a cross-sectional profile that is uniform throughout the article. The uniform cross-sectional profile may be determined by at least one of a visual inspection, scanning electron microscopy, fluorescence microscopy, DSC, TEM, XRD, EPMA, or FTIR. The cross-sectional profile may relate to at least one of a density, an absence of voids, a consistent pattern, or a chemical profile.

As used herein, “interior-void-free” refers to an article that lacks interior voids having a largest physical dimension of between 50 μm and 1 mm or between 50 μm and 200 μm. It should be appreciated that certain porogen approaches could be used to generate an article that has intentionally-placed pores amidst a solid framework that itself is interior-void-free. In this instance, an interior-void-free article could be adapted to possess pores that fall within the size definitions here, but those pores would readily be identified by a skilled artisan as different and distinct from voids that are unintentionally formed in the interior of an article.

As used here, “optically nontransparent” refers to a material having a visible light attenuation for a predetermined visible wavelength (or range of wavelengths) of 50% or greater, including but not limited to, 60% or greater, 70% or greater, 80% or greater, 90% or greater, or 95% or greater.

As used herein, “random sampling” refers to any random or pseudo-random selection of sampling locations from an article. Some techniques may be as close to truly random as possible, while some may be pseudo-random. It is contemplated that the random nature of the sampling may be randomized on an article-by-article basis or may be randomized once for a whole series of articles. As one specific example, a script can be crafted for imaging software to randomly select sampling locations by using a grid array and a random number generator. In some cases, random sampling involves more than one random selection (e.g., a random selection of which cross-section(s) to take of an article, followed by a random selection of which location(s) on the newly-exposed faces to analyze).

As used herein, “representative sampling” refers to a sampling method for assessing an article for a given property that provide a skilled artisan with at least 90%, at least 95%, or at least 99% confidence that the sampling selection provides an accurate measurement of the given property throughout a predetermined volume (e.g., the entire article or a specific region of the article). Naturally, increasing the number of samples taken will increase the confidence. The locations of the samples are chosen or randomly selected to ensure adequate coverage for the above-referenced confidence level. In some cases, representative sampling involves more than one representative selection (e.g., a representative selection of which cross-section(s) to take of an article, followed by a representative selection of which location(s) on the newly-exposed faces to analyze).

As used herein, a “sacrificial” material is a material that is used within the mold in the molding process but will not ultimately be in the article produced. One example of a sacrificial material is an acrylonitrile butadiene styrene (ABS) that can be deposited into a portion of a mold, solidified, and later dissolved by acetone. Other examples include, but are not limited to, polyvinyl alcohol (dissolvable in water), ABS (also dissolvable in alcohol), a variety of materials dissolvable in specialized solvents, or soft materials, such as clay-like materials, that can be introduced and removed principally by physical force.

As used herein, “settling” refers to a process of encouraging a viscous material to occupy a lowest gravity point in a mold, through use of time, force or physical manipulation, or a combination. Settling can include tapping a mold on a surface to settle a viscous material into the mold. Settling can include simply waiting some length of time for gravity to do its work. Settling can include an initial centrifugal spin at a predetermined centrifugal force (e.g., the same as is used in the broader method, lower than is used in the broader method, etc.) to encourage conformity with a mold.

As used herein, a “uniform” property is a property that varies by less than 10%, less than 5%, less than 1%, or less than 0.1% across the entirety of an article, as shown by a random sampling, a representative sampling, or another sampling technique that has been shown to provide statistically valid sampling.

The techniques disclosed herein provide the ability to produce monoliths, or whole and bulk constructs with materials that could previously only be formed into films or 3D printed. The discrepancy between the geometries created with our novel molding process and films is apparent to the observer as we provide the ability to turn a material from a 2D plane to a 3D article. In comparison to objects that are 3D printed with a polymerization solution, we can create complex structures without the distinct patterning of an extrusion path. 3D bio prints are essentially never completely bulk, or have a filled volume, due to the cylindrical shape of the filaments that stack upon each other to form a shape: the bioprinting manufacturing methodology leaves voids within whole constructs due to the gaps between cylindrical extrusions.

One landmark achievement related to this disclosure is the ability to create synthetic bones for mechanical testing, such as dog bones. Synthetic bones require the formation of a bulk material for accurate testing, and the current methodologies of fabricating biopolymers (and other materials that require aqueous assembly) are unable to do that due to the lack of material uniformity and patterning within their products.

The techniques described herein also provide the ability to create complex geometries with a single material, or multiple combinations of materials. With the addition of multi-material molds that possess sacrificial parts, we can integrate a combination of materials in unique patterns. For example, we can create a trachea stent with a two-part mold: the exterior mold can be a Boolean subtraction of the stent geometry that is removed after the material has polymerized. We can create multi-layer constructs by simply stacking them on top of one another in an iterative polymerization process. We can create multi-material constructs that are concentric to each other by concentrically layering the different mold materials; these mold materials can have different conditions for sacrifice, allowing a mixture of different materials to iteratively replace the respectively sacrificed mold part. The same methodology of materials iteratively replacing the respectively sacrificed mold parts can also be utilized for incredible unique geometries, where the sacrificed molds are the negatives of said geometries. (An example would be of a multi-material tissue scaffold where the vasculature was a different material than the surrounding scaffold).

The present disclosure provides a method of making a biopolymer article. The method overcomes significant shortcomings in existing techniques. For example, an alternative to the centrifugal molding process disclosed herein is 3D bioprinting. Indeed, 3D bioprinting has driven major innovations in tissue engineering and in the medical device field. In many cases, a low viscosity bioink is extruded precisely layer-by-layer into a polymerization bath, where it then cures (solvent-directed molecular assembly) into desired geometries with unique properties. Different combinations of bioinks and baths provide the ability to tailor constructs for desirable material and mechanical properties. Solvent-directed assembly of biopolymers proves promising as it has shown great success and potential in 3D bioprinting. However, 3D printing also has its limitations, namely, slow manufacturing time, difficulties in production of bulk materials, scalability, and the need for support baths to produce complex geometries. The disclosure herein addresses the drawbacks of 3D printing while utilizing the advantages and adaptability of solvent-driven biopolymer assembly. Disclosed herein is a novel aqueous, solvent-directed centrifugal molding technique to manufacture biopolymers into devices and bulk materials with tunable material properties.

Many bioinks lack the viscosity or have too high a loss modulus to retain their shape after extrusion. Often, the inks will lose shape and sag leading to unviable geometries and overall print failure. Thus, they are often extruded directly into a polymerization bath to induce cross-linking so that they may retain their intended structure or geometry. Different bioinks require different solvent bath properties to induce cross-linking, but the overall concept of solidifying the extrusion remains the same. For example, chitosan dissolved in acetic acid is a common bioink used in regenerative medicine. It is often extruded into a bath composed of sodium hydroxide to precipitate the chitosan to form a stable hydrogel. Silk is another bioink that can be extruded into a biomimetic salt bath, solvent polymerizes the silk through guided protein assembly, acidification, and dehydration. For inks lacking a sufficient storage modulus, a polymerizing agent in the form of a bath is often required.

Another alternative to the centrifugal molding process disclosed herein is regular molding. Regular molding involves depositing all the material into the mold and then polymerizing the material, however, there are some limitations of this technique. For example, one limitation is maintaining shape fidelity and polymerization when working with a larger structure due to the insufficient penetration of the polymerization bath into a deep volume. Centrifugal molding does not appear to suffer from this limitation, even for large structures. In another example, due to the viscous nature of the biopolymer solutions used, it is not uncommon for air bubbles to enter the solution during casting. In a regular molding process, these bubbles can end up being trapped in the solution, and negatively impacting the shape fidelity and mechanical properties of the resulting part. The centrifugal force applied to the solution removes air bubbles, leading to a much more even structure. In yet another example, for complex geometries, liquid pockets can remain in certain areas of the mold, and their effect on the shape fidelity and mechanics of the resulting implant/device will only become evident once the part is removed from the mold. Once again, due to the centrifugal force applied to the solution, there are no remaining liquid pockets with the centrifugal molding approach.

Another alternative to the centrifugal molding process disclosed herein is thermal molding. Thermal molding involves filling a mold with a lyophilized powder of biopolymer and applying heat and pressure to generate a part. Again, this technique presents limitations that are addressed with a centrifugal molding approach. For example, a basic approach to thermal molding is to generate blanks that are larger than the desired object, and use conventional manufacturing approaches like milling or machining to obtain the resulting parts. This is not scalable, labor intensive, and wasteful (subtractive manufacturing approaches result in much more discarded material than additive manufacturing). A centrifugal molding strategy removes the limitations in terms of scalability and labor (many different parts can be molded simultaneously, by a single operator), and waste products (material is only added until the mold is full, and only a small amount of the resulting part is discarded as part of the post-processing steps). In another example, generating molds for thermal molding that are compatible with complex geometries is possible, but requires extensive research and expertise to have the right parts (for 3 or more-part molds) and the right tolerances to allow proper polymerization. With a centrifugal molding approach, on the other hand, molds can be easily generated through CAD software and can be 3D printed. In yet another example, making changes to an existing mold is a very time-consuming and labor intensive process, since an entirely new mold will have to be generated. This is not compatible with incremental improvements to a design or to a mold. With a centrifugal molding approach, in a few hours it is possible to make an adjustment to a design, 3D print it and validate it with a new biopolymer solution. In embodiments disclosed herein, techniques such as thermal molding, regular molding, and/or machining may be used along with centrifugal molding techniques.

Centrifugal molding may be used in many different applications, such as patients with implantable medical devices (e.g., tympanostomy tubes, nasal stents, septal buttons, nerve capping devices, Kirschner wires, or the like).

Medical devices or implants may be manufactured using biopolymers in aqueous solutions, while preserving one or more of shape fidelity, reliability of the manufacturing process, scalability of manufacturing. making multiple parts simultaneously, generating multimaterial devices, generating composite or multilayered structures, centimeter scale devices, and high resolution of surface features (at least tens of microns, maybe even lower feature sizes, depending on the resolution of the 3D printer used to generate the molds). In embodiments, manufacturing techniques may include robotic manufacturing, hybrid manufacturing, modular manufacturing, or the like. For example, the mold and/or methods may be robotically manipulated to generate articles. In one example, a mold may be adjusted during centrifugation to generate structural features. In another example, the method may be robotically programmed to generate a gradient of additives in an article by modifying centrifugation parameters throughout the process.

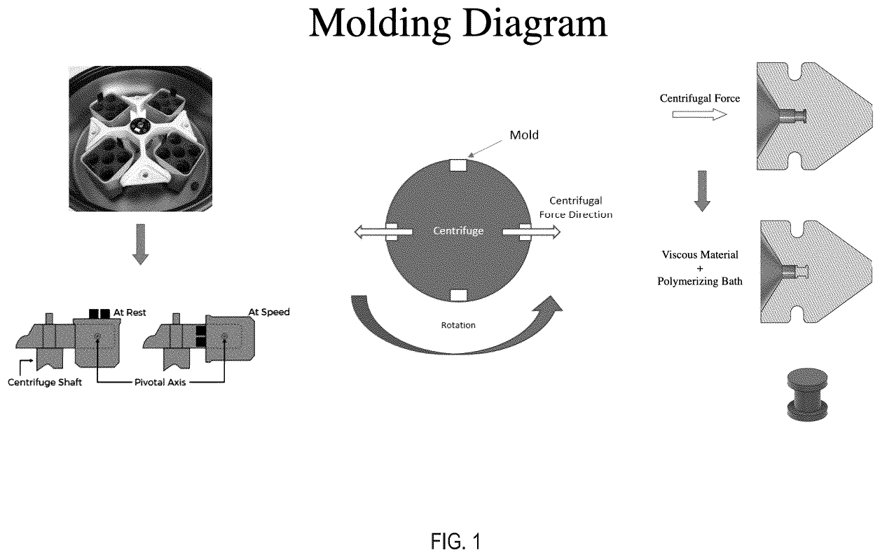

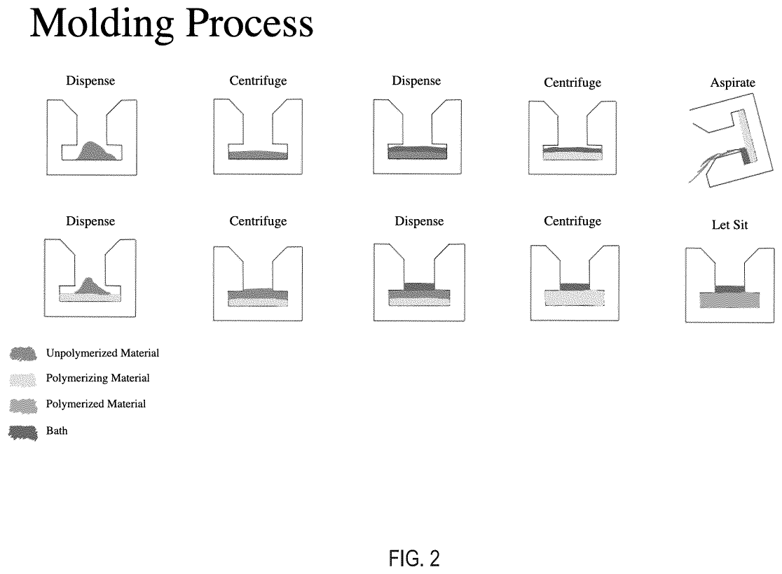

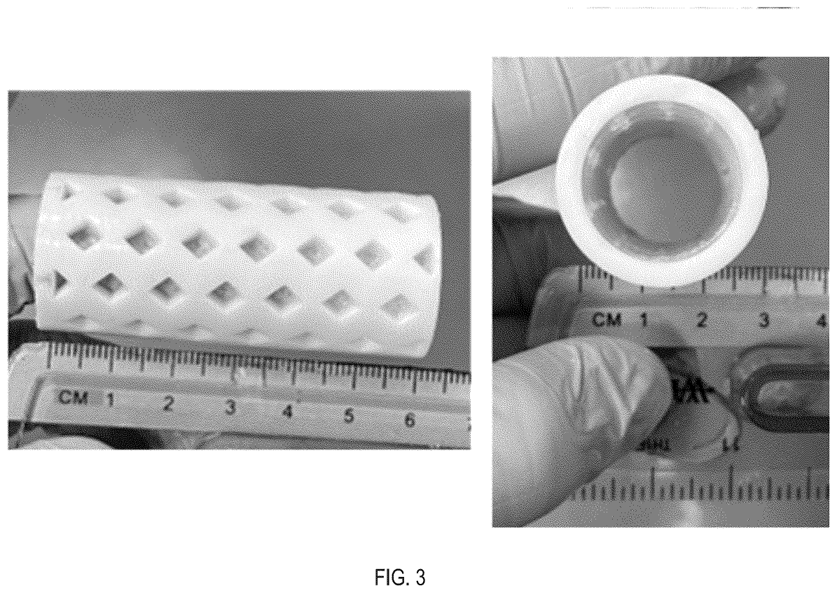

Referring to FIGS. 1-2, diagrams representing the principles of the methods described herein are shown. Referring to FIG. 3, an image of a tubular article made by the disclosed method is shown.

Broadly, the present disclosure comprises centrifuging an early-stage-of-solidification aqueous biopolymer solution within a mold until a first later stage of solidification, thereby forming a first biosolidifying body. Allowing that first biosolidifying body to further solidify can form an article. Alternatively, a second early-stage-of-solidification aqueous biopolymer solution can be added atop the first biosolifidying body until a second later stage of solidification, thereby forming a second biosolidifying body inclusive of the first biosolidifying body. For the avoidance of doubt, in many cases, successively added solutions do not need to have completed their biosolidification prior to introduction of subsequent solutions. In fact, for uniform materials, this is a highly advantageous to add subsequent solutions prior to completion of solidification of the previous layer, because this allows the layers to fully integrate with one another. When a second biosolidifying is inclusive of a first biosolidifying body (or any inclusive of another), it does not mean that the first biosolidifying body is distinguishable within the second biosolidifying body. In many cases, the first biosolidifying body is seamlessly integrated into the second biosolidifying body.

More specifically, a method of the present disclosure can include the following sequential steps: A) introducing a first aqueous biopolymer solution into a mold and optionally settling the first aqueous biopolymer solution into the mold; B) introducing a first aqueous curing solution into the mold atop the first aqueous biopolymer solution and optionally settling the first aqueous curing solution into the mold, wherein the mold has a first orientation relative to gravity during step B); and C) subjecting the mold and contents of the mold to a first centrifugation and stopping after a first centrifugation length of time, thereby producing a first biosolidifying body, wherein the mold is within 45° of the first orientation relative to the first centrifugation during step C. Waiting a first final biosolidifation length of time following step C produces a first biopolymer article from the first biosolidifying body. In some cases, the method includes waiting the first biosolidifcation length of time, thereby forming the first biopolymer article from the first biosolidifying body.

In some cases, the settling of step A) is not optional and is performed. Settling can be achieved in a variety of ways, but centrifugal settling is expressly contemplated. The centrifugation settings disclosed elsewhere herein, or others understood by a skilled artisan to be useful for settling, can be utilized. Manually settling (e.g., tapping on a surface) is also contemplated. The mold can be oriented withing 45° of the first orientation relative to a gravitational force during the settling.

Following steps A-C), the method can further include the following sequential steps: D) introducing a second aqueous biopolymer solution into the mold atop the first biosolidifying body and optionally settling the second aqueous biopolymer solution into the mold; E) introducing a second aqueous curing solution into the mold atop the second aqueous biopolymer solution and optionally settling the second aqueous curing solution into the mold, wherein the mold has a second orientation relative to gravity during step E); and F) subjecting the mold and contents of the mold to a second centrifugation and stopping after a second centrifugation length of time, thereby producing a second biosolidifying body inclusive of the first biosolidifying body, wherein the mold is within 45° of the second orientation relative to the second centrifugation in step F). Waiting a second final biosolidification length of time following step F) produces a second biopolymer article from the second biosolidifying body. In some cases, the method further includes waiting the second biosolidification length of time following step F), thereby producing the second biopolymer article from the second biosolidifying body.

In some cases, the settling of step D) is not optional and is performed. Settling can be achieved in a variety of ways, but centrifugal settling is expressly contemplated. The centrifugation settings disclosed elsewhere herein, or others understood by a skilled artisan to be useful for settling, can be utilized. Manually settling (e.g., tapping on a surface) is also contemplated. The mold can be oriented withing 45° of the second orientation relative to a gravitational force during the settling.

Following steps A-F), the method can further include the following sequential steps: G) introducing a third aqueous biopolymer solution into the mold atop the second biosolidifying body and optionally settling the third aqueous biopolymer solution into the mold; H) introducing a third aqueous curing solution into the mold atop the third aqueous biopolymer solution and optionally settling the third aqueous curing solution into the mold, wherein the mold has a third orientation relative to gravity during step H); and I) subjecting the mold and contents of the mold to a third centrifugation and stopping after a third centrifugation length of time, thereby producing a third biosolidifying body inclusive of the first and second biosolidifying bodies, wherein the mold is within 45° of the third orientation relative to the third centrifugation during step I). Waiting a third final biosolidifcation length of time following step I) produces a third biopolymer article from the third biosolidifying body. In some cases, the method further includes waiting the third biosolidification length of time following step I), thereby producing the third biopolymer article from the third biosolidifying body.

In some cases, the settling of step G) is not optional and is performed. Settling can be achieved in a variety of ways, but centrifugal settling is expressly contemplated. The centrifugation settings disclosed elsewhere herein, or others understood by a skilled artisan to be useful for settling, can be utilized. Manually settling (e.g., tapping on a surface) is also contemplated. The mold can be oriented within 45° of the third orientation relative to a gravitational force during the settling.

Following steps A-I), the method can further include the following sequential steps: J) introducing a fourth aqueous biopolymer solution into the mold atop the third biosolidifying body and optionally settling the fourth aqueous biopolymer solution into the mold; K) introducing a fourth aqueous curing solution into the mold atop the fourth aqueous biopolymer solution and optionally settling the fourth aqueous curing solution into the mold, wherein the mold has a fourth orientation relative to gravity during step J); and L) subjecting the mold and contents of the mold to a fourth centrifugation and stopping after a fourth centrifugation length of time, thereby producing a fourth biosolidifying body inclusive of the first, second, and third biosolidifying bodies, wherein the mold is within 45° of the fourth orientation relative to the fourth centrifugation during step L). Waiting a fourth final biosolidifcation length of time following step L) produces a fourth biopolymer article from the fourth biosolidifying body. In some cases, the method further includes waiting the fourth biosolidification length of time following step L), thereby producing the fourth biopolymer article from the fourth biosolidifying body.

In some cases, the settling of step J) is not optional and is performed. Settling can be achieved in a variety of ways, but centrifugal settling is expressly contemplated. The centrifugation settings disclosed elsewhere herein, or others understood by a skilled artisan to be useful for settling, can be utilized. Manually settling (e.g., tapping on a surface) is also contemplated. The mold can be oriented withing 45° of the third orientation relative to a gravitational force during the settling.

In some cases, the first and second orientation are the same, while in others, they are different. In some cases, such as forming alternating layers, it might be important for the orientations to be the same. While in other cases, such as forming intricate lateral features in an article, it might be important to use different orientations. Similarly, the third orientation can the same or different as the first and second orientation, the fourth orientation can be the same or different as the first, second, and third orientation. The same is true for fifth, sixth, up to nth orientations for respective iterations of these method steps.

As one generalization, the method can include, following steps A-C), steps A-F), steps A-I), or steps A-L), the following sequential steps: X) introducing an additional aqueous biopolymer solution atop existing portions of a biosolidifying body and optionally settling the additional aqueous biopolymer solution into the mold, the existing portions of the biosolidifying body inclusive of the first biosolidifying body and optionally inclusive of the second, third, and fourth biosolidifying bodies; Y) introducing an additional aqueous curing solution into the mold atop the additional aqueous biopolymer solution and optionally settling the additional aqueous curing solution into the mold; and Z) subjecting the mold and the contents of the mold to an additional centrifugation and stopping after an additional centrifugal length of time, thereby producing an additional biosolidifying body inclusive of the existing portions of the biosolidifying body. Waiting an additional final biosolidification length of time following step Z produces an additional biopolymer article from the additional biosolidifying body. In some cases, the method includes waiting the final biosolidification length of time.

As another generalization, the methods can include at least two iterative cycles of the following steps: X) introducing an iterative aqueous biopolymer solution into a mold and optionally settling the iterative aqueous biopolymer solution into the mold; Y) introducing an iterative aqueous curing solution into the mold atop the iterative aqueous biopolymer solution and optionally settling the iterative aqueous curing solution into the mold; and Z) subjecting the mold and the contents of the mold to an iterative centrifugation and stopping after an iterative centrifugal length of time, thereby iteratively adding to existing portions of the solidifying body, the iteratively introducing of step X), introducing of step Y), and subjecting of step Z) continuing until a final biosolidifying body is formed. Waiting a final biosolidification length of time following formation of the final biosolidification body produces the biopolymer article. In some cases, the method includes waiting the final biosolidification length of time.

In some cases, the settling of step X) is not optional and is performed. Settling can be achieved in a variety of ways, but centrifugal settling is expressly contemplated. The centrifugation settings disclosed elsewhere herein, or others understood by a skilled artisan to be useful for settling, can be utilized. Manually settling (e.g., tapping on a surface) is also contemplated. The mold can be oriented withing 45° of the third orientation relative to a gravitational force during the settling.

In some cases, residual aqueous solution may be aspirated from the mold, optionally taking care to not disturb deposited polymers. In some cases, rinsing may also be required. Specifically, in instances where alternating layers of material are desired, if the curing conditions for one of the materials is destructive of the other material (i.e., if an acidic curing solution for one biopolymer would degrade the other biopolymer), then the mold is aspirated and rinsed prior to adding the other biopolymer to the mold.

The size of the mold and the volumes of the liquids added during these methods are not intended to be limiting. While there is not a lower physical limit to the size of articles made by this method, it is acknowledged that very small 1D or 2D articles (e.g., fibers or films) could potentially have been made with existing methods to produce articles having one or more of the aforementioned characteristic centrifugal properties. In other words, there may be some minimal size threshold for the present method to produce materials that are qualitatively different than previously-produced materials. There are also other size thresholds, above which the results achieved by the claimed invention may be even more particularly unexpected. For instance, when an article has an interior point that is at least 0.05 mm, at least 0.1 mm, at least 0.2 mm, at least 0.3 mm, at least 0.4 mm, at least 0.5 mm, at least 1.0 mm, or at least 1.5 mm, from a surface of the article, no previous method has been shown to provide the material properties and uniformity achieved by the disclosed methods.

The centrifugation that is described throughout these methods is somewhat different from the conventional usage of centrifugation, in that the process is not necessarily intended to separate components, but rather helps drive out air bubbles and maintain physical conformity, as described elsewhere herein. As such, the centrifugal arts do not provide much guidance with respect to using centrifuges in this fashion. The inventors surprisingly discovered many benefits to processing materials in the fashion described herein.

The centrifugal force that was used in the examples is 2000×g, though other forces are contemplated, including between 1000×g and 5000×g. The length of centrifugation time can also be adjusted, as desired. The length of centrifugation time can be between 30 seconds and 10 minutes or between 1 minute and an hour. Longer centrifugation times may hold additional advantages, though they would be offset by time and energy consumption.

Each aqueous solution described herein can be degassed prior to usage.

Each aqueous biopolymer solution comprises a respective biopolymer. The biopolymer can be selected from the group consisting of silk fibroin, alginate, fibrinogen, chitosan, collagen, and combinations thereof. These biopolymers can be paired with respective aqueous curing solutions.

One pair is silk fibroin as biopolymer and a curing solution that initiates beta sheet crystallization and/or hydrogel formation.

Fibroin: As used herein, the term “fibroin” includes silkworm silk fibroin and insect or spider silk protein (Lucas et al, Adv. Protein Chem 13:107-242 (1958)). Any type of silk fibroin can be used according to aspects of the present invention. There are many different types of silk produced by a wide variety of species, including, without limitation: Antheraea mylitta; Antheraea pemyi; Antheraea yamamai; Galleria mellonella; Bombyx mori; Bombyx mandarina; Galleria mellonella; Nephila clavipes; Nephila senegalensis; Gasteracantha mammosa; Argiope aurantia; Araneus diadematus; Latrodectus geometricus; Araneus bicentenarius; Tetragnatha versicolor; Araneus ventricosus; Dolomedes tenebrosus; Euagrus chisoseus; Plectreurys tristis; Argiope trifasciata; and Nephila madagascariensis. In some embodiments, fibroin is obtained from a solution containing a dissolved silkworm silk or spider silk. The silkworm silk protein is obtained, for example, from Bombyx mori, and the spider silk is obtained from Nephila clavipes. Other silks include transgenic silks, genetically engineered silks (recombinant silk), such as silks from bacteria, yeast, mammalian cells, transgenic animals, or transgenic plants, and variants thereof. See for example, WO 97/08315 and U.S. Pat. No. 5,245,012, content of both of which is incorporated herein by reference in its entirety. In some embodiments, silk fibroin can be derived from other sources such as spiders, other silkworms, bees, synthesized silk-like peptides, and bioengineered variants thereof. In some embodiments, silk fibroin can be extracted from a gland of silkworm or transgenic silkworms. See for example, WO2007/098951, content of which is incorporated herein by reference in its entirety. Although different species of silk-producing organisms, and different types of silk, have different amino acid compositions, various fibroin proteins share certain structural features. A general trend in silk fibroin structure is a sequence of amino acids that is characterized by usually alternating glycine and alanine, or alanine alone. Such configuration allows fibroin molecules to self-assemble into a beta-sheet conformation. These “Ala-rich” and “Gly-rich” hydrophobic blocks are typically separated by segments of amino acids with bulky side-groups (e.g., hydrophilic spacers). In some embodiments, core repeat sequences of the hydrophobic blocks of fibroin can be represented by the following amino acid sequences and/or formulae: (GAGAS) 5-15 (SEQ ID NO: 1); (GX) 5-15 (X=V, I, A) (SEQ ID NO: 2); GAAS (SEQ ID NO: 3); (S1-2A11-13) (SEQ ID NO: 4); GX1-4 GGX (SEQ ID NO: 5); GGGX (X=A, S, Y, R, D V, W, R, D) (SEQ ID NO: 6); (S1-2A1-4) 1-2 (SEQ ID NO: 7); GLGGLG (SEQ ID NO: 8); GXGGXG (X=L, I, V, P) (SEQ ID NO: 9); GPX (X=L, Y, I); (GP (GGX) 1-4 Y) n (X=Y, V, S, A) (SEQ ID NO: 10); GRGGAn (SEQ ID NO: 11); GGXn (X=A, T, V, S); GAG (A) 6-7GGA (SEQ ID NO: 12); and GGX GX GXX (X=Q, Y, L, A, S, R) (SEQ ID NO: 13). In some embodiments, a fibroin peptide can contain multiple hydrophobic blocks, e.g., 3, 4, 5, 6, 7, 8, 9, 10, 11, 12, 13, 14, 15, 16, 17, 18, 19 and 20 hydrophobic blocks within the peptide. In some embodiments, a fibroin peptide can contain between 4-17 hydrophobic blocks. In some embodiments of the invention, a fibroin peptide comprises at least one hydrophilic spacer sequence (“hydrophilic block”) that is about 4-50 amino acids in length. Non-limiting examples of the hydrophilic spacer sequences include: TGSSGFGPYVNGGYSG (SEQ ID NO: 14); YEYAWSSE (SEQ ID NO: 15); SDFGTGS (SEQ ID NO: 16); RRAGYDR (SEQ ID NO: 17); EVIVIDDR (SEQ ID NO: 18); TTHEDLDITIDGADGPI (SEQ ID NO: 19) and TISEELTI (SEQ ID NO: 20). In certain embodiments, a fibroin peptide can contain a hydrophilic spacer sequence that is a derivative of any one of the representative spacer sequences listed above. Such derivatives are at least 75%, at least 80%, at least 85%, at least 90%, or at least 95% identical to any one of the hydrophilic spacer sequences. In some embodiments, a fibroin peptide suitable for the present invention contains no spacer. Silks are generally fibrous proteins and characterized by modular units linked together to form high molecular weight, highly repetitive proteins. These modular units or domains, each with specific amino acid sequences and chemistries, are thought to provide specific functions. For example, sequence motifs such as poly-alanine (poly A) and poly-alanine-glycine (poly-AG) are inclined to be beta-sheet-forming; GXX motifs contribute to 31-helix formation; GXG motifs provide stiffness; and, GPGXX (SEQ ID NO: 22) contributes to beta-spiral formation. These are examples of different components in various silk structures whose positioning and arrangement are tied with the end material properties of silk-based materials (reviewed in Omenetto and Kaplan (2010) Science 329:528-531). Also see: WO 2011/130335 (PCT/US2011/032195), the contents of which are incorporated herein by reference for all purposes.

One pair is alginate as biopolymer and a curing solution that is a calcium ion solution.

One pair is fibrinogen as biopolymer and a curing solution that is a thrombin solution that cleaves and polymerized fibrinogen into fibrin.

One pair is chitosan as biopolymer, where the chitosan is acidic, and a curing solution that is a neutralizing agent that neutralizes the acid and solidifies the chitosan. Chitosan, naturally occurring polysaccharide biopolymer, and its derivatives are non-toxic, biocompatible, and biodegradable with certain important biological properties, such as intrinsic antimicrobial properties, mucoadhesion, and permeability enhancing properties, which may be imparted to articles comprising chitosan or a derivative thereof. Other biological activities may include antifungal, antitumor, anticancer, anti-diabetic, wound healing, and antioxidant activities. Depending on the degree of deacetylation, the degree of modification, and/or the molecular weight (MW) of chitosan, certain properties (e.g., bioactivity, biocompatibility, and biodegradability) may be present, absent, enhanced, or less prominent. Example curing solutions to be used with chitosan include sodium hydroxide, a mixture of sodium hydroxide and ethanol, ethanol, urea (carbamide), carbonic acid, or sodium tripolyphosphate.

One pair is collagen as biopolymer and a curing solution that is a pH adjusting agent or series of buffering solutions that direct collagen self-assembly.

When multiple different polymers and solutions are used, some compatibility between polymers is required, as will be appreciate by one having ordinary skill in the art. One exemplary combination is silk fibroin and chitosan, where alternating layers are quite strong, perhaps due to electrostatic interactions between the negatively charged silk layer and the positively charged chitosan layer.

In some cases, the first, second, third, fourth, and/or iterative aqueous biopolymer solution and/or the first, second, third, fourth, and/or iterative aqueous curing solution can further comprise one or more additives. In some cases, the additive can be introduced into the mold prior to introducing one of the aqueous solutions. In these cases, the solutions fill and solidify around additives that do not dissolve and/or dissolve/suspend additives that are dissolvable or suspensible.

The additives can include nanoparticles, microparticles, structural altering materials, and/or bioactive materials. Nanoparticles/microparticles can include silk, metal, semiconductor nanoparticles, ceramics, magnetic particles, contrast agents, and/or radioopaque particles. Structural altering materials include, without limitation, fibers (including microfibers/nanofibers), fabric, a scaffold, a foam, a plasticizer, carbon nanotubes, and/or a porogen. Bioactive materials include cells and/or growth factors or other biologics. Other examples of bioactive materials include, but are not limited to, enzymes, antibiotics, anti-inflammatory drugs, analgesics, chemotherapeutic agents, miRNA, mRNA, siRNA, or the like.

In cases where the additive is impacted by gravitational forces, the location of the additive may be important. For instance, adding a bulky additive too early in a process may cause the additive to all gather at the “bottom” of the mold, while adding too late may result in the additive remaining at the “top” of the mold. For addition within the biopolymer solution, the additive is simply incorporated into the solution and care is taken to ensure that centrifugal forces or centrifugation times (or combinations of forces and times) are controlled to ensure that the additive does not crash out of the structure. For the addition of additives via the polymerization agent solution, it's very important to characterize the g-force and centrifugal time required for the additives to penetrate and travel/permeate through the polymer solution. If g-force is too high or the centrifugal time is too long, the additives will migrate to the bottom of the layer and possibly even penetrate a previously deposited layer. If the g-force is too low or the centrifugal time is too short, the additives will not penetrate the polymer solution, and will sit topically on the polymer solution as its own distinct layer (although this can be considered a separate feature also). It is also important to consider the impact that centrifugation has on previously deposited layers and additives. Viscosity, polymerization time, material density, additive density, and layer height are all confounding factors that influence the centrifugal force and time. It should be appreciated that centrifugal force and centrifugation timing could be adjusted to produce a predetermined gradient of additives, if the additives are responsive to gravitational force.

The molds used herein can have a variety of features that are suitable for use with the present disclosure. In some cases, the molds can have internal features that are intricate and produce article features that cannot be produced otherwise. In some cases, the molds can have mounting posts or other mounting features that allow the mold to be forcible held at a desired angle during centrifugation. In other words, the molds can have anchor points that produce a predictable orientation under the force of gravity.

The mold can itself be 3D printed. The methods described herein can involve 3D printing. If a desired article shape is known, a skilled artisan can tailor a negative mold from 3D printing techniques known to those having ordinary skill in the arts. The molds used herein may be made from 3D printing materials, graphite, ceramic, stainless steel, iron, steel, aluminum, nickel, copper, acrylic, polylactic acid, polyamide, nylon, or combinations thereof.

In some cases, the mold can have multiple parts. In one specific embodiment, the mold has a top mold portion, which is positioned atop the solutions and provides shaping to a top surface of the biosolidifying article and/or eventual article.

A variety of sacrificial materials can be utilized during these techniques to make more complex geometries. For example, a sacrificial material can be introduced in a portion of the mold, remain present during portions of the method, then removed and portions of the method are performed in locations that were previously occupied by the sacrificial material. One example of a sacrificial material is acrylonitrile butadiene styrene (ABS), which can be removed using acetone or an alcohol. Other sacrificial mold materials include, but are not limited to, polyvinyl alcohol, inert clays, and the like.

The article produced by the methods described herein can take a variety of forms, and the specific forms mentioned here are not intended to be limiting. The article can be a medical device. Exemplary articles include, but are not limited to, a catheter, a stent, an ear tube, a septal button, a nerve capping device, a Kirshner wire, an artificial lens, a dental implant, a bone scaffold, a spinal implant, a plate, a screw, a pin, a rod, a tissue scaffold, collagenic structures, a tendon scaffold, or the like.

In some cases, the article can be a microfluidic device or a microfluidic chip. One particular approach for forming microfluidics involves physical etching, which is a design attribute of this process. The molds used herein can be designed to have a positive topography of a microfluidic device, which will be imprinted into the resulting article upon formation under the centrifugal methods described herein. Because the force ensures strong contact between the article and the mold, these features transfer highly reliably.

The biosolidifying bodies and articles described herein can be processed in a variety of ways, including but not limited to, chemically cross-linking, physically cross-linking, chemically etching, chemically smoothing, chain extending and/or branching polymers, and/or chemically functionalizing.

The articles described herein can be machined into different useful shapes.

While the present disclosure is described in the context of biopolymers specifically, it is contemplated that the methods may be more broadly applicable to other aqueous processing methods and/or other aqueous polymer systems.

Disclosed herein is a controlled centrifugal solidification biopolymer article. The controlled centrifugal solidification biopolymer article is not a film. At least a portion of the article includes at least one characteristic centrifugal property selected from the group consisting of: a uniform density, optically nontransparent, free of exterior layering, free of interior layering, interior-void-free, free of cylindrical extrusion gaps, and free of layering. In examples, the controlled centrifugal solidification biopolymer article includes at least two of the disclosed at least one characteristic centrifugal properties. In examples, the controlled centrifugal solidification biopolymer article includes at least three of the disclosed at least one characteristic centrifugal properties. In examples, the controlled centrifugal solidification biopolymer article includes at least four of the disclosed at least one characteristic centrifugal properties. In examples, the controlled centrifugal solidification biopolymer article includes at least five of the disclosed at least one characteristic centrifugal properties. In examples, the controlled centrifugal solidification biopolymer article includes at least six of the disclosed at least one characteristic centrifugal properties. In examples, the controlled centrifugal solidification biopolymer article includes at least seven of the disclosed at least one characteristic centrifugal properties.

Disclosed herein is a method of centrifugal controlled biosolidification molding. The method includes the following sequential steps: A) introducing a first aqueous biopolymer solution into a mold and optionally settling the first aqueous biopolymer solution into the mold, B) introducing a first aqueous curing solution into the mold atop the first aqueous biopolymer solution and optionally settling the first aqueous curing solution into the mold, wherein the mold has a first orientation relative to gravity during step B), and C) subjecting the mold and contents of the mold to a first centrifugation and stopping after a first centrifugation length of time, thereby producing a first biosolidifying body, wherein the mold is within 45° of the first orientation relative to the first centrifugation during step C). Waiting a first final biosolidification length of time following step C) produces a first biopolymer article from the first biosolidifying body.

In some examples, step A) includes settling the first aqueous biopolymer solution into the mold. In examples, settling includes subjecting the mold and the contents of the mold to a settling centrifugation and stopping after a settling centrifugation length of time, thereby conforming the first biopolymer solution to the geometry of the mold, wherein the mold is within 45° of the first orientation relative to the first centrifugation during step B) during the settling centrifugation. In examples, settling includes tapping the mold and the contents of the mold on a surface, thereby conforming the first biopolymer solution to geometry of the mold, wherein the mold is within 45° of the first orientation relative to the first centrifugation during step B) during the tapping.

In some examples, the method further includes waiting the first final biosolidification length of time following step C), thereby producing the first biopolymer article.

In some examples, the first aqueous biopolymer solution is an aqueous silk solution, an aqueous alginate solution, an aqueous fibrinogen solution, an aqueous chitosan solution, an aqueous collagen solution, or a combination thereof. In an example, the first aqueous biopolymer solution is the aqueous silk solution and the first aqueous curing solution is an aqueous silk crosslinking and/or hydrogel initiating solution. In another example, the first aqueous biopolymer solution is the aqueous alginate solution and the first aqueous curing solution is an aqueous alginate crosslinking solution. In yet another example, the first aqueous biopolymer solution is the aqueous fibrinogen solution and the first aqueous curing solution is an aqueous fibrinogen curing solution. In still another example, the first aqueous biopolymer solution is the aqueous collagen solution and the first aqueous curing solution is an aqueous collagen curing solution.

In some examples, the method further includes the following sequential steps: D) introducing a second aqueous biopolymer solution into the mold atop the first biosolidifying body and optionally settling the second aqueous biopolymer solution into the mold, E) introducing a second aqueous curing solution into the mold atop the second aqueous biopolymer solution and optionally settling the second aqueous curing solution into the mold, wherein the mold has a second orientation relative to gravity during step E), and F) subjecting the mold and contents of the mold to a second centrifugation and stopping after a second centrifugation length of time, thereby producing a second biosolidifying body inclusive of the first biosolidifying body, wherein the mold is within 45° of the second orientation relative to the second centrifugation in step F). Waiting a second final biosolidification length of time following step F) produces a second biopolymer article from the second biosolidifying body. In examples, the method further includes waiting the second final biosolidication length of time following step F), thereby producing the second biopolymer article. The second orientation may be the same as the first orientation or different from the first orientation. In an example, the method further includes the following steps: G) introducing a third aqueous biopolymer solution into the mold atop the second biosolidifying body and optionally settling the third aqueous biopolymer solution into the mold, H) introducing a third aqueous curing solution into the mold atop the third aqueous biopolymer solution and optionally settling the third aqueous curing solution into the mold, wherein the mold has a third orientation relative to gravity during step H), and I) subjecting the mold and contents of the mold to a third centrifugation and stopping after a third centrifugation length of time, thereby producing a third biosolidifying body inclusive of the first and second biosolidifying bodies, wherein the mold is within 45° of the third orientation relative to the third centrifugation during step I), and wherein waiting a third final biosolidifcation length of time following step I) produces a third biopolymer article from the third biosolidifying body. In the example, the method may further include waiting the third final solidification length of time following step I), thereby producing the third biopolymer article. In the example, the method may further include the following sequential steps: J) introducing a fourth aqueous biopolymer solution into the mold atop the third biosolidifying body and optionally settling the fourth aqueous biopolymer solution into the mold, K) introducing a fourth aqueous curing solution into the mold atop the fourth aqueous biopolymer solution and optionally settling the fourth aqueous curing solution into the mold, wherein the mold has a fourth orientation relative to gravity during step J), and L) subjecting the mold and contents of the mold to a fourth centrifugation and stopping after a fourth centrifugation length of time, thereby producing a fourth biosolidifying body inclusive of the first, second, and third biosolidifying bodies, wherein the mold is within 45° of the fourth orientation relative to the fourth centrifugation during step L), wherein waiting a fourth final biosolidifcation length of time following step L) produces a fourth biopolymer article from the fourth biosolidifying body. In this example, the method may further include waiting the third final solidification length of time following step L), thereby producing the third biopolymer article.

In some examples, the method further includes the following sequential steps: X) introducing an additional aqueous biopolymer solution atop existing portions of a biosolidifying body and optionally settling the additional aqueous biopolymer solution into the mold, the existing portions of the biosolidifying body inclusive of the first biosolidifying body and optionally inclusive of the second, third, and fourth biosolidifying bodies, Y) introducing an additional aqueous curing solution into the mold atop the additional aqueous biopolymer solution and optionally settling the additional aqueous curing solution into the mold, and Z) subjecting the mold and the contents of the mold to an additional centrifugation and stopping after an additional centrifugal length of time, thereby producing an additional biosolidifying body inclusive of the existing portions of the biosolidifying body, wherein waiting an additional final biosolidification length of time following step Z) producing an additional biopolymer article from the additional biosolidifying body. In an example, the method further includes waiting the additional final solidification length of time following step Z), thereby producing the additional biopolymer article.

Disclosed herein is a method of making a biopolymer article including at least two iterative cycles of the following steps: X) introducing an iterative aqueous biopolymer solution into a mold and optionally settling the iterative aqueous biopolymer solution into the mold, Y) introducing an iterative aqueous curing solution into the mold atop the iterative aqueous biopolymer solution and optionally settling the iterative aqueous curing solution into the mold, and Z) subjecting the mold and the contents of the mold to an iterative centrifugation and stopping after an iterative centrifugal length of time, thereby iteratively adding to existing portions of the solidifying body, the iteratively introducing of step X), introducing of step Y), and subjecting of step Z) continuing until a final biosolidifying body is formed, wherein waiting a final biosolidification length of time following formation of the final biosolidification body produces the biopolymer article. The method may further include waiting the final biosolidification length of time following step Z), thereby producing the biopolymer article.

Disclosed herein is a method including centrifuging a first early-stage-of-solidification aqueous biopolymer solution within a mold until a first later stage of solidification, thereby forming a first biosolidifying body. In an example, the method further includes centrifuging a second early-stage-of-solidification aqueous biopolymer solution within the mold atop the first biosolidifying body until a second later stage of solidification, thereby forming a second biosolidifying body inclusive of the first biosolidifying body.

In any of the disclosed methods herein, the mold is three-dimensional printed. In any of the disclosed methods herein, the method includes three-dimensional printing the mold prior to step A).

In any of the disclosed methods herein, sacrificial molding is used during the method. For example, the sacrificial molding is acrylonitrile butadiene styrene. In an example, the method includes removing the sacrificial molding using acetone or an alcohol.

In any of the disclosed methods herein, a top mold is present during one or more centrifugation steps, thereby introducing additional molding to one or more of the biosolidifying articles.

In any of the disclosed methods herein, a first biopolymer of the first aqueous biopolymer solution, a second biopolymer of the second biopolymer solution, a third biopolymer of the third biopolymer solution, a fourth biopolymer of the fourth biopolymer solution, and/or an iterative biopolymer of the iterative biopolymer solution is selected from the group consisting of silk fibroin, alginate, fibrinogen, chitosan, collagen, and combinations thereof. In an example, the first, second, third, fourth, and/or iterative biopolymer is silk fibroin. In an example, the first, second, third, fourth, and/or iterative curing solution is a beta sheet initiation or hydrogel initiation composition. In an example, the first, second, third, fourth, and/or iterative biopolymer is alginate. In this example, the first, second, third, fourth, and/or iterative curing solution is a calcium ion solution. In an example, the first, second, third, fourth, and/or iterative biopolymer is fibrinogen. In this example, the first, second, third, fourth, and/or iterative curing solution is a thrombin solution that cleaves and polymerizes fibrinogen into fibrin. In an example, the first, second, third, fourth, and/or iterative biopolymer is chitosan. In this example, the chitosan is acidic, wherein the first, second, third, fourth, and/or iterative curing solution is a neutralizing agent that neutralizes the acid and solidifies the chitosan. In an example, the first, second, third, fourth, and/or iterative biopolymer is collagen. In this example, the collagen is acidic, wherein the first, second, third, fourth, and/or iterative curing solution is a pH adjusting agent that directs collagen self-assembly.

In any of the disclosed methods herein, the method further includes chemically cross-linking the first, second, third, fourth, or final biosolidifying body or the first, second, third, fourth, or final biopolymer article.

In any of the disclosed methods herein, the method further includes physically cross-linking the first, second, third, fourth, or final biosolidifying body or the first, second, third, fourth, or final biopolymer article.

In any of the disclosed methods herein, the method further includes chemically etching the first, second, third, fourth, or final biosolidifying body or the first, second, third, fourth, or final biopolymer article.

In any of the disclosed methods herein, the method further includes chemically smoothing the first, second, third, fourth, or final biosolidifying body or the first, second, third, fourth, or final biopolymer article.

In any of the disclosed methods herein, the method further includes chain extending and/or branching polymers in the first, second, third, fourth, or final biosolidifying body or the first, second, third, fourth, or final biopolymer article.

In any of the disclosed methods herein, the method further includes chemically functionalizing the first, second, third, fourth, or final biosolidifying body or the first, second, third, fourth, or final biopolymer article.

In any of the disclosed methods herein, the method further includes degassing the first, second, third, fourth, and/or iterative aqueous biopolymer solution and/or the first, second, third, fourth, and/or iterative aqueous curing solution.

In any of the disclosed methods herein, the first, second, third, fourth, and/or iterative aqueous biopolymer solution and/or the first, second, third, fourth, and/or iterative aqueous curing solution further includes an additive. In an example, the first aqueous biopolymer solution includes the additive. In an example, the second aqueous biopolymer solution includes the additive. In an example, the third aqueous biopolymer solution includes the additive. In an example, the fourth aqueous biopolymer solution includes the additive. In an example, the iterative aqueous biopolymer solution includes the additive. In an example, the first aqueous curing solution includes the additive. In an example, the second aqueous curing solution includes the additive. In an example, the third aqueous curing solution includes the additive. In an example, the fourth aqueous curing solution includes the additive. In an example, the iterative aqueous curing solution includes the additive. In examples, the additive includes nanoparticles, a structural altering material, or a bioactive material. The structural altering material may include fibers, fabric, a scaffold, a foam, a plasticizer, or a porogen. In one example, the additive may be a degradable metal mesh, such as a magnesium-based mesh (e.g., with a centrifugal coat). In embodiments, the mesh could be either present in the mold ahead of time, or added between polymerization steps. The nanoparticles include silk nanoparticles, metal nanoparticles, or semiconductor nanoparticles. The bioactive material includes one or more cells, or one or more growth factors.

In any of the disclosed methods herein, the mold, prior to introducing the first, second, third, fourth, and/or iterative aqueous biopolymer solution and/or the first, second, third, fourth, and/or iterative aqueous curing solution into the mold, contains a structural altering material. The structural altering material includes fibers, fabric, a scaffold, a foam, a plasticizer, or a porogen.

In any of the disclosed methods herein, the mold, prior to introducing the first, second, third, fourth, and/or iterative aqueous biopolymer solution and/or the first, second, third, fourth, and/or iterative aqueous curing solution into the mold, contains nanoparticles. The nanoparticles include silk nanoparticles, metal nanoparticles, or semiconductor nanoparticles.

In any of the disclosed methods herein, the mold, prior to introducing the first, second, third, fourth, and/or iterative aqueous biopolymer solution and/or the first, second, third, fourth, and/or iterative aqueous curing solution into the mold, contains bioactive material. The bioactive material includes one or more cells, or one or more growth factors.

Disclosed herein is an article made by the method of any of the disclosed methods herein. In an example, the article is at least a portion of a medical device. For example, the article or the medical device is a catheter, a stent, an ear tube, a septal button, a nerve capping device, a Kirshner wire, an artificial lens, a dental implant, a bone scaffold, a spinal implant, a plate, a screw, a pin, a rod, or a combination thereof.

Disclosed herein is a controlled centrifugal solidification chitosan article, wherein the article is not a film. At least a portion of the article includes at least one characteristic centrifugal property selected from the group consisting of: i) a uniform density across the at least a portion of the article; ii) the at least a portion of the article is optically nontransparent; iii) the at least a portion of the article is free of exterior layering; iv) the at least a portion of the article is free of interior layering; v) the at least a portion of the article is interior-void-free; vi) the at least a portion of the article is free of cylindrical extrusion gaps; and vii) the at least a portion of the article is free of layering.

Disclosed herein is a method of centrifugal controlled chitosan biosolidification molding. The method includes the following sequential steps: A) introducing a chitosan solution into a mold and optionally settling the chitosan solution into the mold; B) introducing a chitosan curing solution into the mold atop the chitosan solution and optionally settling the chitosan curing solution into the mold, wherein the mold has a first orientation relative to gravity during step B); and C) subjecting the mold and contents of the mold to a first centrifugation and stopping after a first centrifugation length of time, thereby producing a first biosolidifying body, wherein the mold is within 45° of the first orientation relative to the first centrifugation during step C). Waiting a first final biosolidification length of time following step C) produces a first biopolymer article from the first biosolidifying body.

In an example method, settling comprises subjecting the mold and the contents of the mold to a settling centrifugation and stopping after a settling centrifugation length of time, thereby conforming the chitosan solution to geometry of the mold, wherein the mold is within 45° of the first orientation relative to the first centrifugation during step B) during the settling centrifugation.

In an example method, settling includes tapping the mold and the contents of the mold on a surface, thereby conforming the chitosan solution to geometry of the mold, wherein the mold is within 45° of the first orientation relative to the first centrifugation during step B) during the tapping.

The example method further includes waiting the first final biosolidification length of time following step C), thereby producing the first biopolymer article.

In an example method, the aqueous chitosan curing solution is sodium hydroxide, ethanol, or a combination thereof.

The example method further includes the following sequential steps: D) introducing a second aqueous biopolymer solution into the mold atop the first biosolidifying body and optionally settling the second aqueous biopolymer solution into the mold; E) introducing a second aqueous curing solution into the mold atop the second aqueous biopolymer solution and optionally settling the second aqueous curing solution into the mold, wherein the mold has a second orientation relative to gravity during step E); and F) subjecting the mold and contents of the mold to a second centrifugation and stopping after a second centrifugation length of time, thereby producing a second biosolidifying body inclusive of the first biosolidifying body, wherein the mold is within 45° of the second orientation relative to the second centrifugation in step F). Waiting a second final biosolidification length of time following step F) produces a second biopolymer article from the second biosolidifying body. In the example, the method further includes waiting the second final biosolidication length of time following step F), thereby producing the second biopolymer article. In the example, the second orientation is the same as the first orientation. In the example, the second orientation is different than the first orientation. In the example, the method further includes the following steps: G) introducing a third aqueous biopolymer solution into the mold atop the second biosolidifying body and optionally settling the third aqueous biopolymer solution into the mold; H) introducing a third aqueous curing solution into the mold atop the third aqueous biopolymer solution and optionally settling the third aqueous curing solution into the mold, wherein the mold has a third orientation relative to gravity during step H); and I) subjecting the mold and contents of the mold to a third centrifugation and stopping after a third centrifugation length of time, thereby producing a third biosolidifying body inclusive of the first and second biosolidifying bodies, wherein the mold is within 45° of the third orientation relative to the third centrifugation during step I). Waiting a third final biosolidifcation length of time following step I) produces a third biopolymer article from the third biosolidifying body. In the example, the method further includes waiting the third final solidification length of time following step I), thereby producing the third biopolymer article. In the example, the method further includes the following sequential steps: J) introducing a fourth aqueous biopolymer solution into the mold atop the third biosolidifying body and optionally settling the fourth aqueous biopolymer solution into the mold; K) introducing a fourth aqueous curing solution into the mold atop the fourth aqueous biopolymer solution and optionally settling the fourth aqueous curing solution into the mold, wherein the mold has a fourth orientation relative to gravity during step J); and L) subjecting the mold and contents of the mold to a fourth centrifugation and stopping after a fourth centrifugation length of time, thereby producing a fourth biosolidifying body inclusive of the first, second, and third biosolidifying bodies, wherein the mold is within 45° of the fourth orientation relative to the fourth centrifugation during step L). Waiting a fourth final biosolidifcation length of time following step L) produces a fourth biopolymer article from the fourth biosolidifying body. In the example, the method further includes waiting the third final solidification length of time following step L), thereby producing the third biopolymer article.

An example method further includes the following sequential steps: X) introducing an additional aqueous biopolymer solution atop existing portions of a biosolidifying body and optionally settling the additional aqueous biopolymer solution into the mold, the existing portions of the biosolidifying body inclusive of the first biosolidifying body and optionally inclusive of the second, third, and fourth biosolidifying bodies; Y) introducing an additional aqueous curing solution into the mold atop the additional aqueous biopolymer solution and optionally settling the additional aqueous curing solution into the mold; and Z) subjecting the mold and the contents of the mold to an additional centrifugation and stopping after an additional centrifugal length of time, thereby producing an additional biosolidifying body inclusive of the existing portions of the biosolidifying body. Waiting an additional final biosolidification length of time following step Z) producing an additional biopolymer article from the additional biosolidifying body. In the example, the method further includes waiting the additional final solidification length of time following step Z), thereby producing the additional biopolymer article.

In an example method, the second, third, or fourth aqueous biopolymer solution is an aqueous silk solution, an aqueous alginate solution, an aqueous fibrinogen solution, an aqueous chitosan solution, an aqueous collagen solution, or a combination thereof. When the aqueous biopolymer solution is the aqueous silk solution, the corresponding second, third, fourth, or additional aqueous curing solution is an aqueous silk crosslinking and/or hydrogel initiating solution. When the aqueous biopolymer solution is the aqueous alginate solution, the second, third, fourth, or additional aqueous curing solution is an aqueous alginate crosslinking solution. When the aqueous biopolymer solution is the aqueous fibrinogen solution, the second, third, fourth, or additional aqueous curing solution is an aqueous fibrinogen curing solution. When the aqueous biopolymer solution is the aqueous collagen solution, the second, third, fourth, or additional aqueous curing solution is an aqueous collagen curing solution. When the aqueous biopolymer solution is the aqueous chitosan solution, the second, third, fourth, or additional aqueous curing solution is an aqueous chitosan curing solution (e.g., sodium hydroxide, ethanol, or a combination thereof).

In an example method, sacrificial molding is used. The sacrificial molding is acrylonitrile butadiene styrene. The method includes removing the sacrificial molding using acetone or an alcohol.

In an example method, the chitosan, second, third, fourth, and/or additional aqueous biopolymer solution and/or the chitosan, second, third, fourth, and/or additional aqueous curing solution further comprises an additive (e.g., nanoparticles, a structural altering material, or a bioactive material).

According to various embodiments, a variety of functionalizing agents may be used with the silk-containing embodiments described herein (e.g., silk membrane, silk composition, silk articles, silk matrix, silk foam, silk microsphere, liquid composition, whipped silk cream, silk meringue, compressed silk meringue, hot-pressed silk meringue, silk leather, silk powder, silk toner, etc.). It should be understood that the examples herein may recite one or a few silk-containing embodiments but are applicable to any silk-containing embodiment, as applicable. In some embodiments, a functionalizing agent may be any compound or molecule that facilitates the attachment to and/or development (e.g., growth) of one or more endothelial cells on a silk membrane. In some embodiments, a functionalizing agent may be any compound or molecule that facilitates the attachment and/or development (e.g., growth) of one or more megakaryocytes and/or hematopoietic progenitor cells on a silk matrix and/or silk membrane. In some embodiments, a functionalizing agent may be or comprise an agent suitable for facilitating the production of one or more of white blood cells and red blood cells.

In some embodiments, a functionalizing agent may be or comprise a cell attachment mediator and/or an extracellular matrix protein, for example: collagen (e.g., collagen type I, collagen type III, collagen type IV or collagen type VI), elastin, fibronectin, vitronectin, laminin, fibrinogen, von Willebrand factor, proteoglycans, decorin, perlecan, nidogen, hyaluronan, and/or peptides containing known integrin binding domains e.g. “RGD” integrin binding sequence, or variations thereof, that are known to affect cellular attachment.

In some embodiments, a functionalizing agent may be any soluble molecule produced by endothelial cells. Non-limiting examples include fibroblast growth factor-1 (FGF1) and vascular endothelial growth factors (VEGF).

According to some embodiments, a plurality of functionalizing agents may be used. For example, in some embodiments wherein production of platelets is desired, provided compositions may comprise the use of laminin, fibronectin and/or fibrinogen, and type IV collagen in order to facilitate the attachment and growth of endothelial cells on a silk membrane (e.g., a porous silk membrane) and/or attachment of megakaryocytes to a silk matrix.

In some embodiments, a functionalizing agent may be embedded or otherwise associated with a silk membrane and/or silk matrix such that at least a portion of the functionalizing agent is surrounded by a silk membrane and/or silk matrix as contrasted to a functionalizing agent simply being positioned along the surface of a silk membrane and/or silk matrix. In some embodiments, a functionalizing agent is distributed along and/or incorporated in substantially the entire surface area of a silk membrane/silk wall. In some embodiments, a functionalizing agent is distributed and/or incorporated only at one or more discrete portions of a silk membrane/wall and/or silk matrix. In some embodiments, a functionalizing agent is distributed in and/or along at least one of the lumen-facing side of a silk wall and the matrix-facing side of a silk wall.

According to various embodiments, any application-appropriate amount of one or more functionalizing agents may be used. In some embodiments, the amount of an individual functionalizing agent may be between about 1 μg/ml and 1,000 μg/ml (e.g., between about 2 and 1,000, 5 and 1,000, 10 and 1,000, 10 and 500, 10 and 100 μg/ml). In some embodiments, the amount of an individual functionalizing agent may be at least 1 μg/ml (e.g., at least 5, 10, 15, 20 25, 50, 100, 200, 300 400, 500, 600, 700, 800, or 900 μg/ml). In some embodiments, the amount of an individual functionalizing agent is at most 1,000 μg/ml (e.g., 900, 800, 700, 600, 500, 400, 300 200, 100, 90, 80, 70, 60, 50, 40, 30, 20, 10, or 5 μg/ml).

In some aspects, the composition comprises one or more sensing agents, such as a sensing dye. The sensing agents/sensing dyes are environmentally sensitive and produce a measurable response to one or more environmental factors. In some aspects, the environmentally-sensitive agent or dye may be present in the composition in an effective amount to alter the composition from a first chemical-physical state to a second chemical-physical state in response to an environmental parameter (e.g., a change in pH, light intensity or exposure, temperature, pressure or strain, voltage, physiological parameter of a subject, and/or concentration of chemical species in the surrounding environment) or an externally applied stimulus (e.g., optical interrogation, acoustic interrogation, and/or applied heat). In some cases, the sensing dye is present to provide one optical appearance under one given set of environmental conditions and a second, different optical appearance under a different given set of environmental conditions. Suitable concentrations for the sensing agents described herein can be the concentrations for the colorants and additives described elsewhere herein. A person having ordinary skill in the chemical sensing arts can determine a concentration that is appropriate for use in a sensing application of the inks described herein.

In some aspects, the first and second chemical-physical state may be a physical property of the composition, such as mechanical property, a chemical property, an acoustical property, an electrical property, a magnetic property, an optical property, a thermal property, a radiological property, or an organoleptic property. Exemplary sensing dyes or agents include, but are not limited to, a pH sensitive agent, a thermal sensitive agent, a pressure or strain sensitive agent, a light sensitive agent, or a potentiometric agent.

Exemplary pH sensitive dyes or agents include, but are not limited to, cresol red, methyl violet, crystal violet, ethyl violet, malachite green, methyl green, 2-(p-dimethylaminophenylazo) pyridine, paramethyl red, metanil yellow, 4-phenylazodiphenylamine, thymol blue, metacresol purple, orange IV, 4-o-Tolylazo-o-toluindine, quinaldine red, 2,4-dinitrophenol, erythrosine disodium salt, benzopurpurine 4B, N,N-dimethyl-p-(m-tolylazo) aniline, p-dimethylaminoazobenene, 4,4′-bis(2-amino-1-naphthylazo)-2,2′-stilbenedisulfonic acid, tetrabromophenolphthalein ethyl ester, bromophenol blue, Congo red, methyl orange, ethyl orange, 4-(4-dimethylamino-1-naphylazo)-3-methoxybenesulfonic acid, bromocresol green, resazurin, 4-phenylazo-1-napthylamine, ethyl red 2-(1-dimethylaminophenyazo) pyridine, 4-(p-ethoxypehnylazo)-m-phenylene-diamine monohydrochloride, resorcin blue, alizarin red S, methyl red, propyl red, bromocresol purple, chlorophenol red, p-nitrophenol, alizarin 2-(2,4-dinitrophenylazo) 1-napthol-3,6-disulfonic acid, bromothymol blue, 6,8-dinitro-2,4-(1H) quinazolinedione, brilliant yellow, phenol red, neutral red, m-nitrophenol, cresol red, turmeric, metacresol purple, 4,4′-bis(3-amino-1-naphthylazo)-2,2′-stilbenedisulfonic acid, thymol blue, p-naphtholbenzein, phenolphthalein, o-cresolphthalein, ethyl bis(2,4-dimethylphenyl) ethanoate, thymolphthalein, nitrazine yellow, alizarin yellow R, alizarin, p-(2,4-dihydroxyphenylazo) benzenesulfonic acid, 5,5′-indigodisulfonic acid, 2,4,6-trinitrotoluene, 1,3,5-trinitrobenezne, and clayton yellow.

Exemplary light responsive dyes or agents include, but are not limited to, photochromic compounds or agents, such as triarylmethanes, stilbenes, azasilbenes, nitrones, fulgides, spiropyrans, napthopyrans, spiro-oxzines, quinones, derivatives and combinations thereof.

Exemplary potentiometric dyes include, but are not limited to, substituted amiononaphthylehenylpridinium (ANEP) dyes, such as di-4-ANEPPS, di-8-ANEPPS, and N-(4-Sulfobutyl)-4-(6-(4-(Dibutylamino)phenyl) hexatrienyl) Pyridinium (RH237).

Exemplary temperature sensitive dyes or agents include, but are not limited to, thermochromic compounds or agents, such as thermochromic liquid crystals, leuco dyes, fluoran dyes, octadecylphosphonic acid.

Exemplary pressure or strain sensitive dyes or agents include, but are not limited to, spiropyran compounds and agents.

Exemplary chemi-sensitive dyes or agents include, but are not limited to, antibodies such as immunoglobulin G (IgG) which may change color from blue to red in response to bacterial contamination.

In some aspects, the compositions comprise one or more additive, dopant, or biologically active agent suitable for a desired intended purpose. In some aspects, the additive or dopant may be present in the composition in an amount effective to impart an optical or organoleptic property to the composition. Exemplary additives or dopants that impart optical or organoleptic properties include, but are not limited to, dyes/pigments, flavorants, aroma compounds, granular or fibrous fillers.

Additionally or alternatively, the additive, dopant, or biologically active agent may be present in the composition in an amount effective to “functionalize” the composition to impart a desired mechanical property or added functionality to the composition. Exemplary additive, dopants, or biologically active agent that impart the desired mechanical property or added functionality include, but are not limited to: environmentally sensitive/sensing dyes; active biomolecules; conductive or metallic particles; micro and nanofibers (e.g., silk nanofibers for reinforcement, carbon nanofibers); nanotubes; inorganic particles (e.g., hydroxyapatite, tricalcium phosphate, bioglasses); drugs (e.g., antibiotics, small molecules or low molecular weight organic compounds); proteins and fragments or complexes thereof (e.g., enzymes, antigens, antibodies and antigen-binding fragments thereof); DNA/RNA (e.g., siRNA, miRNA, mRNA); cells and fractions thereof (viruses and viral particles; prokaryotic cells such as bacteria; eukaryotic cells such as mammalian cells and plant cells; fungi).

In some aspects, the additive or dopant comprises a flavoring agent or flavorant.

Exemplary flavorants include ester flavorants, amino acid flavorants, nucleic acid flavorants, organic acid flavorants, and inorganic acid flavorants, such as, but not limited to, diacetyl, acetylpropionyl, acetoin, isoamyl acetate, benzaldehyde, cinnamaldehyde, ethyl propionate, methyl anthranilate, limonene, ethyl decadienoate, allyl hexanoate, ethyl maltol, ethylvanillin, methyl salicylate, manzanate, glutamic acid salts, glycine salts, guanylic acids salts, inosinic acid salts, acetic acid, ascorbic acid, citric acid, fumaric acid, lactic acid, malic acid, phosphoric acid, tartaric acid, derivatives, and mixtures thereof.

In some aspects, the additive or dopant comprises an aroma compound. Exemplary aroma compounds include ester aroma compounds, terpene aroma compounds, cyclic terpenes, and aromatic aroma compounds, such as, but not limited to, geranyl acetate, methyl formate, methyl acetate, methyl propionate, methyl butyrate, ethyl acetate, ethyl butyrate, isoamyl acetate, pentyl butrate, pentyl pentanoate, octyl acetate, benzyl acetate, methyl anthranilate, myrecene, geraniol, nerol, citral, cironellal, cironellol, linalool, nerolidol, limonene, camphor, menthol, carone, terpineol, alpha-lonone, thujone, eucalyptol, benzaldehyde, eugenol, cinnamaldehyde, ethyl maltol, vanillin, anisole, anethole, estragole, thymol.

In some aspects, the additive or dopant comprises a colorant, such as a dye or pigment. In some aspects, the dye or pigment imparts a color or grayscale to the composition. The colorant can be different than the sensing agents and/or sensing dyes below. Any organic and/or inorganic pigments and dyes can be included in the inks. Exemplary pigments suitable for use in the present disclosure include International Color Index or C.I. Pigment Black Numbers 1, 7, 1 1 and 31, C.I. Pigment Blue Numbers 15, 15:1, 15:2, 15:3, 15:4, 15:6, 16, 27, 29, 61 and 62, C.I. Pigment Green Numbers 7, 17, 18 and 36, C.I. Pigment Orange Numbers 5, 13, 16, 34 and 36, C.I. Pigment Violet Numbers 3, 19, 23 and 27, C.I. Pigment Red Numbers 3, 17, 22, 23, 48:1, 48:2, 57:1, 81:1, 81:2, 81:3, 81:5, 101, 1 14, 122, 144, 146, 170, 176, 179, 181, 185, 188, 202, 206, 207, 210 and 249, C.I. Pigment Yellow Numbers 1, 2, 3, 12, 13, 14, 17, 42, 65, 73, 74, 75, 83, 30, 93, 109, 1 10, 128, 138, 139, 147, 142, 151, 154 and 180, D&C Red No. 7, D&C Red No. 6 and D&C Red No. 34, carbon black pigment (such as Regal 330, Cabot Corporation), quinacridone pigments (Quinacridone Magenta (228-0122), available from Sun Chemical Corporation, Fort Lee, N.J.), diarylide yellow pigment (such as AAOT Yellow (274-1788) available from Sun Chemical Corporation); and phthalocyanine blue pigment (such as Blue 15:3 (294-1298) available from Sun Chemical Corporation). The classes of dyes suitable for use in present invention can be selected from acid dyes, natural dyes, direct dyes (either cationic or anionic), basic dyes, and reactive dyes. The acid dyes, also regarded as anionic dyes, are soluble in water and mainly insoluble in organic solvents and are selected, from yellow acid dyes, orange acid dyes, red acid dyes, violet acid dyes, blue acid dyes, green acid dyes, and black acid dyes. European Patent 0745651, incorporated herein by reference, describes a number of acid dyes that are suitable for use in the present disclosure. Exemplary yellow acid dyes include Acid Yellow 1 International Color Index or C.I. 10316); Acid Yellow 7 (C.I. 56295); Acid Yellow 17 (C.I. 18965); Acid Yellow 23 (C.I. 19140); Acid Yellow 29 (C.I. 18900); Acid Yellow 36 (C.I. 13065); Acid Yellow 42 (C.I. 22910); Acid Yellow 73 (C.I. 45350); Acid Yellow 99 (C.I. 13908); Acid Yellow 194; and Food Yellow 3 (C.I. 15985). Exemplary orange acid dyes include Acid Orange 1 (C.I. 13090/1); Acid Orange 10 (C.I. 16230); Acid Orange 20 (C.I. 14603); Acid Orange 76 (C.I. 18870); Acid Orange 142; Food Orange 2 (C.I. 15980); and Orange B.

Exemplary red acid dyes include Acid Red 1. (C.I. 18050); Acid Red 4 (C.I. 14710); Acid Red 18 (C.I. 16255), Acid Red 26 (C.I. 16150); Acid Red 2.7 (C.I. as Acid Red 51 (C.I. 45430, available from BASF Corporation, Mt. Olive, N.J.) Acid Red 52 (C.I. 45100); Acid Red 73 (C.I. 27290); Acid Red 87 (C. I. 45380); Acid Red 94 (C.I. 45440) Acid Red 194; and Food Red 1 (C.I. 14700). Exemplary violet acid dyes include Acid Violet 7 (C.I. 18055); and Acid Violet 49 (C.I. 42640). Exemplary blue acid dyes include Acid Blue 1 (C.I. 42045); Acid Blue 9 (C.I. 42090); Acid Blue 22 (C.I. 42755); Acid Blue 74 (C.I. 73015); Acid Blue 93 (C.I. 42780); and Acid Blue 158A (C.I. 15050). Exemplary green acid dyes include Acid Green 1 (C.I. 10028); Acid Green 3 (C.I. 42085); Acid Green 5 (C.I. 42095); Acid Green 26 (C.I. 44025); and Food Green 3 (C.I. 42053). Exemplary black acid dyes include Acid Black 1 (C.I. 20470); Acid Black 194 (Basantol® X80, available from BASF Corporation, an azo/1:2 CR-complex.

Exemplary direct dyes for use in the present disclosure include Direct Blue 86 (C.I. 74180); Direct Blue 199; Direct Black 168; Direct Red 253; and Direct Yellow 107/132 (C.I. Not Assigned).

Exemplary natural dyes for use in the present disclosure include Alkanet (C.I. 75520,75530); Annafto (C.I. 75120); Carotene (C.I. 75130); Chestnut; Cochineal (C.I.75470); Cutch (C.I. 75250, 75260); Divi-Divi; Fustic (C.I. 75240); Hypernic (C.I. 75280); Logwood (C.I. 75200); Osage Orange (C.I. 75660); Paprika; Quercitron (C.I. 75720); Sanrou (C.I. 75100); Sandal Wood (C.I. 75510, 75540, 75550, 75560); Sumac; and Tumeric (C.I. 75300). Exemplary reactive dyes for use in the present disclosure include Reactive Yellow 37 (monoazo dye); Reactive Black 31 (disazo dye); Reactive Blue 77 (phthalo cyanine dye) and Reactive Red 180 and Reactive Red 108 dyes. Suitable also are the colorants described in The Printing Ink Manual (5th ed., Leach et al. eds. (2007), pages 289-299. Other organic and inorganic pigments and dyes and combinations thereof can be used to achieve the colors desired.

In addition to or in place of visible colorants, compositions provided herein can contain ETV fluorophores that are excited in the ETV range and emit light at a higher wavelength (typically 400 nm and above). Examples of ETV fluorophores include but are not limited to materials from the coumarin, benzoxazole, rhodamine, napthalimide, perylene, benzanthrones, benzoxanthones or benzothia-xanthones families. The addition of a UV fluorophore (such as an optical brightener for instance) can help maintain maximum visible light transmission. The amount of colorant, when present, generally is between 0.05% to 5% or between 0.1% and 1% based on the weight of the composition.

For non-white compositions, the amount of pigment/dye generally is present in an amount of from at or about 0.1 wt % to at or about 20 wt % based on the weight of the composition. In some applications, a non-white ink can include 15 wt % or less pigment/dye, or 10 wt % or less pigment/dye or 5 wt % pigment/dye, or 1 wt % pigment/dye based on the weight of the composition. In some applications, a non-white ink can include 1 wt % to 10 wt %, or 5 wt % to 15 wt %, or 10 wt % to 20 wt % pigment/dye based on the weight of the composition. In some applications, a non-white ink can contain an amount of dye/pigment that is 1 wt %, 2 wt %, 3 wt %, 4 wt %, 5%, 6 wt %, 7 wt %, 8 wt %, 9 wt %, 10 wt %, 11 wt %, 12 wt %, 13 wt %, 14 wt %, 15%, 16 wt %, 17 wt %, 18 wt %, 19 wt % or 20 wt % based on the weight of the composition.

For white compositions, the amount of white pigment generally is present in an amount of from at or about 1 wt % to at or about 60 wt % based on the weight of the composition. In some applications, greater than 60 wt % white pigment can be present. Preferred white pigments include titanium dioxide (anatase and rutile), zinc oxide, lithopone (calcined coprecipitate of barium sulfate and zinc sulfide), zinc sulfide, blanc fixe and alumina hydrate and combinations thereof, although any of these can be combined with calcium carbonate. In some applications, a white ink can include 60 wt % or less white pigment, or 55 wt % or less white pigment, or 50 wt % white pigment, or 45 wt % white pigment, or 40 wt % white pigment, or 35 wt % white pigment, or 30 wt % white pigment, or 25 wt % white pigment, or 20 wt % white pigment, or 15 wt % white pigment, or 10 wt % white pigment, based on the weight of the composition. In some applications, a white ink can include 5 wt % to 60 wt %, or 5 wt % to 55 wt %, or 10 wt % to 50 wt %, or 10 wt % to 25 wt %, or 25 wt % to 50 wt %, or 5 wt % to 15 wt %, or 40 wt % to 60 wt % white pigment based on the weight of the composition. In some applications, a non-white ink can an amount of dye/pigment that is 5%, 6 wt %, 7 wt %, 8 wt %, 9 wt %, 10 wt %, 11 wt %, 12 wt %, 13 wt %, 14 wt %, 15%, 16 wt %, 17 wt %, 18 wt %, 19 wt %, 20 wt %, 21 wt %, 22 wt %, 23 wt %, 24 wt %, 25%, 26 wt %, 27 wt %, 28 wt %, 29 wt %, 30 wt %, 31 wt %, 32 wt %, 33 wt %, 34 wt %, 35%, 36 wt %, 37 wt %, 38 wt %, 39 wt %, 40 wt %, 41 wt %, 42 wt %, 43 wt %, 44 wt %, 45%, 46 wt %, 47 wt %, 48 wt %, 49 wt %, 50 wt %, 51 wt %, 52 wt %, 53 wt %, 54 wt %, 55%, 56 wt %, 57 wt %, 58 wt %, 59 wt % or 60 wt % based on the weight of the composition.

In some aspects, the additive or dopant comprises a conductive additive. Exemplary conductive additives include, but are not limited to graphite, graphite powder, carbon nanotubes, and metallic particles or nanoparticles, such as gold nanoparticles. In some aspects, the conductive additive is biocompatible and non-toxic.

In some aspects, the additive is a biologically active agent. The term “biologically active agent” as used herein refers to any molecule which exerts at least one biological effect in vivo. For example, the biologically active agent can be a therapeutic agent to treat or prevent a disease state or condition in a subject. Biologically active agents include, without limitation, organic molecules, inorganic materials, proteins, peptides, nucleic acids (e.g., genes, gene fragments, gene regulatory sequences, and antisense molecules), nucleoproteins, polysaccharides, glycoproteins, and lipoproteins. Classes of biologically active compounds that can be incorporated into the composition provided herein include, without limitation, anticancer agents, antibiotics, analgesics, anti-inflammatory agents, immunosuppressants, enzyme inhibitors, antihistamines, anti-convulsants, hormones, muscle relaxants, antispasmodics, ophthalmic agents, prostaglandins, anti-depressants, anti-psychotic substances, trophic factors, osteoinductive proteins, growth factors, and vaccines.

The term “active agent” may also be used herein to refer to a biological sample (e.g., a sample of tissue or fluid, such as for instance blood) or a component thereof, and/or to a biologically active entity or compound, and/or to a structurally or functionally labile entity.

Exemplary active agents include, but are not limited to, therapeutic agents, diagnostic agents (e.g., contrast agents), and any combinations thereof. In some embodiments, the active agent present in a silk matrix (e.g., a silk microsphere), composition, or the like can include a labile active agent, e.g., an agent that can undergo chemical, physical, or biological change, degradation and/or deactivation after exposure to a specified condition, e.g., high temperatures, high humidity, light exposure, and any combinations thereof. In some embodiments, the active agent present in the silk matrix (e.g., a silk microsphere), composition, or the like can include a temperature-sensitive active agent, e.g., an active agent that will lose at least about 30% or more, of its original activity or bioactivity, upon exposure to a temperature of at least about 10° C. or above, including at least about 15° C. or above, at least about room temperature or above, or at least about body temperature (e.g., about 37° C.) or above.

The active agent can be generally present in the silk matrix (e.g., a silk microsphere), composition, or the like in an amount of about 0.01% (w/w) to about 70% (w/w), or about 0.1% (w/w) to about 50% (w/w), or about 1% (w/w) to about 30% (w/w). The active agent can be present on a surface of the silk matrix (e.g., a silk microsphere), composition, or the like and/or encapsulated and dispersed in the silk matrix (e.g., a silk microsphere), composition, or the like homogeneously or heterogeneously or in a gradient. In some embodiments, the active agent can be added into the silk solution, which is then subjected to the methods described herein for preparing a silk matrix (e.g., a silk microsphere), composition, or the like. In some embodiments, the active agent can be coated on a surface of the silk matrix (e.g., a silk microsphere), composition, or the like. In some embodiments, the active agent can be loaded in a silk matrix (e.g., a silk microsphere), composition, or the like by incubating the silk microsphere in a solution of the active agent for a period of time, during which an amount of the active agent can diffuse into the silk matrix (e.g., a silk microsphere), composition, or the like, and thus distribute within the silk matrix (e.g., a silk microsphere), composition, or the like.

In some aspects, the additive is a therapeutic agent. As used herein, the term “therapeutic agent” means a molecule, group of molecules, complex or substance administered to an organism for diagnostic, therapeutic, preventative medical, or veterinary purposes. As used herein, the term “therapeutic agent” includes a “drug” or a “vaccine.” This term include externally and internally administered topical, localized and systemic human and animal pharmaceuticals, treatments, remedies, nutraceuticals, cosmeceuticals, biologicals, devices, diagnostics and contraceptives, including preparations useful in clinical and veterinary screening, prevention, prophylaxis, healing, wellness, detection, imaging, diagnosis, therapy, surgery, monitoring, cosmetics, prosthetics, forensics and the like. This term can also be used in reference to agriceutical, workplace, military, industrial and environmental therapeutics or remedies comprising selected molecules or selected nucleic acid sequences capable of recognizing cellular receptors, membrane receptors, hormone receptors, therapeutic receptors, microbes, viruses or selected targets comprising or capable of contacting plants, animals and/or humans. This term can also specifically include nucleic acids and compounds comprising nucleic acids that produce a therapeutic effect, for example deoxyribonucleic acid (DNA), ribonucleic acid (RNA), nucleic acid analogues (e.g., locked nucleic acid (LNA), peptide nucleic acid (PNA), xeno nucleic acid (XNA)), or mixtures or combinations thereof, including, for example, DNA nanoplexes, siRNA, microRNA, shRNA, aptamers, ribozymes, decoy nucleic acids, antisense nucleic acids, RNA activators, and the like. Generally, any therapeutic agent can be included in the composition provided herein.

The term “therapeutic agent” also includes an agent that is capable of providing a local or systemic biological, physiological, or therapeutic effect in the biological system to which it is applied. For example, the therapeutic agent can act to control infection or inflammation, enhance cell growth and tissue regeneration, control tumor growth, act as an analgesic, promote anti-cell attachment, and enhance bone growth, among other functions. Other suitable therapeutic agents can include anti-viral agents, hormones, antibodies, or therapeutic proteins. Other therapeutic agents include prodrugs, which are agents that are not biologically active when administered but, upon administration to a subject are converted to biologically active agents through metabolism or some other mechanism. Additionally, a silk-based drug delivery composition can contain one therapeutic agent or combinations of two or more therapeutic agents.

A therapeutic agent can include a wide variety of different compounds, including chemical compounds and mixtures of chemical compounds, e.g., small organic or inorganic molecules; saccharines; oligosaccharides; polysaccharides; biological macromolecules, e.g., peptides, proteins, and peptide analogs and derivatives; peptidomimetics; antibodies and antigen binding fragments thereof; nucleic acids; nucleic acid analogs and derivatives; an extract made from biological materials such as bacteria, plants, fungi, or animal cells; animal tissues; naturally occurring or synthetic compositions; and any combinations thereof. In some aspects, the therapeutic agent is a small molecule.

The term “bioactivity,” as used herein in reference to an active agent, generally refers to the ability of an active agent to interact with a biological target and/or to produce an effect on a biological target. For example, bioactivity can include, without limitation, elicitation of a stimulatory, inhibitory, regulatory, toxic or lethal response in a biological target. The biological target can be a molecule or a cell. For example, a bioactivity can refer to the ability of an active agent to modulate the effect/activity of an enzyme, block a receptor, stimulate a receptor, modulate the expression level of one or more genes, modulate cell proliferation, modulate cell division, modulate cell morphology, or any combination thereof. In some instances, a bioactivity can refer to the ability of a compound to produce a toxic effect in a cell. Exemplary cellular responses include, but are not limited to, lysis, apoptosis, growth inhibition, and growth promotion; production, secretion, and surface expression of a protein or other molecule of interest by the cell; membrane surface molecule activation including receptor activation; transmembrane ion transports; transcriptional regulations; changes in viability of the cell; changes in cell morphology; changes in presence or expression of an intracellular component of the cell; changes in gene expression or transcripts; changes in the activity of an enzyme produced within the cell; and changes in the presence or expression of a ligand and/or receptor (e.g., protein expression and/or binding activity). Methods for assaying different cellular responses are well known to one of skill in the art, e.g., western blot for determining changes in presence or expression of an endogenous protein of the cell, or microscopy for monitoring the cell morphology in response to the active agent, or FISH and/or qPCR for the detection and quantification of changes in nucleic acids. Bioactivity can be determined in some embodiments, for example, by assaying a cellular response.

In reference to an antibody, the term “bioactivity” includes, but is not limited to, epitope or antigen binding affinity, the in vivo and/or in vitro stability of the antibody, the immunogenic properties of the antibody, e.g., when administered to a human subject, and/or the ability to neutralize or antagonize the bioactivity of a target molecule in vivo or in vitro. The aforementioned properties or characteristics can be observed or measured using art-recognized techniques including, but not limited to, scintillation proximity assays, ELISA, ORIGEN immunoassay (IGEN), fluorescence quenching, fluorescence ELISA, competitive ELISA, SPR analysis including, but not limited to, SPR analysis using a BIAcore biosensor, in vitro and in vivo neutralization assays (see, for example, International Publication No. WO 2006/062685), receptor binding, and immunohistochemistry with tissue sections from different sources including human, primate, or any other source as needed. In reference to an immunogen, the “bioactivity” includes immunogenicity, the definition of which is discussed in detail later. In reference to a virus, the “bioactivity” includes infectivity, the definition of which is discussed in detail later. In reference to a contrast agent, e.g., a dye, the “bioactivity” refers to the ability of a contrast agent when administered to a subject to enhance the contrast of structures or fluids within the subject's body. The bioactivity of a contrast agent also includes, but is not limited to, its ability to interact with a biological environment and/or influence the response of another molecule under certain conditions.

As used herein, the term “small molecule” can refer to compounds that are “natural product-like,” however, the term “small molecule” is not limited to “natural product-like” compounds. Rather, a small molecule is typically characterized in that it contains several carbon-carbon bonds, and has a molecular weight of less than 5000 Daltons (5 kDa), preferably less than 3 kDa, still more preferably less than 2 kDa, and most preferably less than 1 kDa. In some cases it is preferred that a small molecule have a molecular weight equal to or less than 700 Daltons.

Exemplary therapeutic agents include, but are not limited to, those found in Harrison's Principles of Internal Medicine, 13th Edition, Eds. T. R. Harrison et al. McGraw-Hill N.Y., NY; Physicians' Desk Reference, 50th Edition, 1997, Oradell New Jersey, Medical Economics Co.; Pharmacological Basis of Therapeutics, 8th Edition, Goodman and Gilman, 1990; United States Pharmacopeia, The National Formulary, ETSP XII NF XVII, 1990, the complete contents of all of which are incorporated herein by reference.

Therapeutic agents include the herein disclosed categories and specific examples. It is not intended that the category be limited by the specific examples. Those of ordinary skill in the art will recognize also numerous other compounds that fall within the categories and that are useful according to the present disclosure. Examples include a radiosensitizer, a steroid, a xanthine, a beta-2-agonist bronchodilator, an anti-inflammatory agent, an analgesic agent, a calcium antagonist, an angiotensin-converting enzyme inhibitors, a beta-blocker, a centrally active alpha-agonist, an alpha-1-antagonist, an anticholinergic/antispasmodic agent, a vasopressin analogue, an anti arrhythmic agent, an antiparkinsonian agent, an antiangina/antihypertensive agent, an anticoagulant agent, an antiplatelet agent, a sedative, an ansiolytic agent, a peptidic agent, a biopolymeric agent, an antineoplastic agent, a laxative, an antidiarrheal agent, an antimicrobial agent, an antifungal agent, a vaccine, a protein, or a nucleic acid. In a further aspect, the pharmaceutically active agent can be coumarin, albumin, steroids such as betamethasone, dexamethasone, methylprednisolone, prednisolone, prednisone, triamcinolone, budesonide, hydrocortisone, and pharmaceutically acceptable hydrocortisone derivatives; xanthines such as theophylline and doxophylline; beta-2-agonist bronchodilators such as salbutamol, fenterol, clenbuterol, bambuterol, salmeterol, fenoterol; antiinflammatory agents, including antiasthmatic anti-inflammatory agents, antiarthritis antiinflammatory agents, and non-steroidal antiinflammatory agents, examples of which include but are not limited to sulfides, mesalamine, budesonide, salazopyrin, diclofenac, pharmaceutically acceptable diclofenac salts, nimesulide, naproxene, acetaminophen, ibuprofen, ketoprofen and piroxicam; analgesic agents such as salicylates; calcium channel blockers such as nifedipine, amlodipine, and nicardipine; angiotensin converting enzyme inhibitors such as captopril, benazepril hydrochloride, fosinopril sodium, trandolapril, ramipril, lisinopril, enalapril, quinapril hydrochloride, and moexipril hydrochloride; beta-blockers (i.e., beta adrenergic blocking agents) such as sotalol hydrochloride, timolol maleate, esmolol hydrochloride, carteolol, propanolol hydrochloride, betaxolol hydrochloride, penbutolol sulfate, metoprolol tartrate, metoprolol succinate, acebutolol hydrochloride, atenolol, pindolol, and bisoprolol fumarate; centrally active alpha-2-agonists such as clonidine; alpha-1-antagonists such as doxazosin and prazosin; anticholinergic/antispasmodic agents such as dicyclomine hydrochloride, scopolamine hydrobromide, glycopyrrolate, clidinium bromide, flavoxate, and oxybutynin; vasopressin analogues such as vasopressin and desmopressin; antiarrhythmic agents such as quinidine, lidocaine, tocainide hydrochloride, mexiletine hydrochloride, digoxin, verapamil hydrochloride, propafenone hydrochloride, flecainide acetate, procainamide hydrochloride, moricizine hydrochloride, and disopyramide phosphate; antiparkinsonian agents, such as dopamine, L-Dopa/Carbidopa, selegiline, dihydroergocryptine, pergolide, lisuride, apomorphine, and bromocryptine; antiangina agents and antihypertensive agents such as isosorbide mononitrate, isosorbide dinitrate, propranolol, atenolol and verapamil; anticoagulant and antiplatelet agents such as Coumadin, warfarin, acetylsalicylic acid, and ticlopidine; sedatives such as benzodiazepines and barbiturates; ansiolytic agents such as lorazepam, bromazepam, and diazepam; peptidic and biopolymeric agents such as calcitonin, leuprolide and other LHRH agonists, hirudin, cyclosporin, insulin, somatostatin, protirelin, interferon, desmopressin, somatotropin, thymopentin, pidotimod, erythropoietin, interleukins, melatonin, granulocyte/macrophage-CSF, and heparin; antineoplastic agents such as etoposide, etoposide phosphate, cyclophosphamide, methotrexate, 5-fluorouracil, vincristine, doxorubicin, cisplatin, hydroxyurea, leucovorin calcium, tamoxifen, flutamide, asparaginase, altretamine, mitotane, and procarbazine hydrochloride; laxatives such as senna concentrate, casanthranol, bisacodyl, and sodium picosulphate; antidiarrheal agents such as difenoxine hydrochloride, loperamide hydrochloride, furazolidone, diphenoxylate hdyrochloride, and microorganisms; vaccines such as bacterial and viral vaccines; antimicrobial agents such as penicillins, cephalosporins, and macrolides, antifungal agents such as imidazolic and triazolic derivatives; and nucleic acids such as DNA sequences encoding for biological proteins, and antisense oligonucleotides.

Anti-cancer agents include alkylating agents, platinum agents, antimetabolites, topoisomerase inhibitors, antitumor antibiotics, antimitotic agents, aromatase inhibitors, thymidylate synthase inhibitors, DNA antagonists, farnesyltransferase inhibitors, pump inhibitors, histone acetyltransferase inhibitors, metalloproteinase inhibitors, ribonucleoside reductase inhibitors, TNF alpha agonists/antagonists, endothelinA receptor antagonists, retinoic acid receptor agonists, immuno-modulators, hormonal and antihormonal agents, photodynamic agents, and tyrosine kinase inhibitors.

Antibiotics include aminoglycosides (e.g., gentamicin, tobramycin, netilmicin, streptomycin, amikacin, neomycin), bacitracin, corbapenems (e.g., imipenem/cislastatin), cephalosporins, colistin, methenamine, monobactams (e.g., aztreonam), penicillins (e.g., penicillin G, penicillinV, methicillin, natcillin, oxacillin, cloxacillin, dicloxacillin, ampicillin, amoxicillin, carbenicillin, ticarcillin, piperacillin, mezlocillin, azlocillin), polymyxin B, quinolones, and vancomycin; and bacteriostatic agents such as chloramphenicol, clindanyan, macrolides (e.g., erythromycin, azithromycin, clarithromycin), lincomyan, nitrofurantoin, sulfonamides, tetracyclines (e.g., tetracycline, doxycycline, minocycline, demeclocyline), and trimethoprim. Also included are metronidazole, fluoroquinolones, and ritampin.

Enzyme inhibitors are substances which inhibit an enzymatic reaction. Examples of enzyme inhibitors include edrophonium chloride, N-methylphysostigmine, neostigmine bromide, physostigmine sulfate, tacrine, tacrine, 1-hydroxy maleate, iodotubercidin, p-bromotetramiisole, 10-(alpha-diethylaminopropionyl)-phenothiazine hydrochloride, calmidazolium chloride, hemicholinium-3,3,5-dinitrocatechol, diacylglycerol kinase inhibitor I, diacylglycerol kinase inhibitor II, 3-phenylpropargylamine, N°-monomethyl-Larginine acetate, carbidopa, 3-hydroxybenzylhydrazine, hydralazine, clorgyline, deprenyl, hydroxylamine, iproniazid phosphate, 6-MeO-tetrahydro-9H-pyrido-indole, nialamide, pargyline, quinacrine, semi carb azide, tranylcypromine, N,N-diethylaminoethyl-2,2-diphenylvalerate hydrochloride, 3-isobutyl-1-methylxanthne, papaverine, indomethacind, 2-cyclooctyl-2-hydroxy ethylamine hydrochloride, 2,3-dichloro-a-methylbenzylamine (DCMB), 8,9-dichloro-2,3,4,5-tetrahydro-IH-2-benzazepine hydrochloride, p-amino glutethimide, p-aminoglutethimide tartrate, 3-iodotyrosine, alpha-methyltyrosine, acetazolamide, dichlorphenamide, 6-hydroxy-2-benzothiazolesulfonamide, and allopurinol.

Antihistamines include pyrilamine, chlorpheniramine, and tetrahydrazoline, among others.

Anti-inflammatory agents include corticosteroids, nonsteroidal anti-inflammatory drugs (e.g., aspirin, phenylbutazone, indomethacin, sulindac, tolmetin, ibuprofen, piroxicam, and fenamates), acetaminophen, phenacetin, gold salts, chloroquine, D-Penicillamine, methotrexate colchicine, allopurinol, probenecid, and sulfinpyrazone.

Muscle relaxants include mephenesin, methocarbomal, cyclobenzaprine hydrochloride, trihexylphenidyl hydrochloride, levodopa/carbidopa, and biperiden.

Anti-spasmodics include atropine, scopolamine, oxyphenonium, and papaverine.

Analgesics include aspirin, phenybutazone, idomethacin, sulindac, tolmetic, ibuprofen, piroxicam, fenamates, acetaminophen, phenacetin, morphine sulfate, codeine sulfate, meperidine, nalorphine, opioids (e.g., codeine sulfate, fentanyl citrate, hydrocodone bitartrate, loperamide, morphine sulfate, noscapine, norcodeine, normorphine, thebaine, nor-binaltorphimine, buprenorphine, chlomaltrexamine, funaltrexamione, nalbuphine, nalorphine, naloxone, naloxonazine, naltrexone, and naltrindole), procaine, lidocain, tetracaine and dibucaine. Ophthalmic agents include sodium fluorescein, rose bengal, methacholine, adrenaline, cocaine, atropine, alpha-chymotrypsin, hyaluronidase, betaxalol, pilocarpine, timolol, timolol salts, and combinations thereof.

Prostaglandins are art recognized and are a class of naturally occurring chemically related long-chain hydroxy fatty acids that have a variety of biological effects.

Anti-depressants are substances capable of preventing or relieving depression.

Examples of anti-depressants include imipramine, amitriptyline, nortriptyline, protriptyline, desipramine, amoxapine, doxepin, maprotiline, tranylcypromine, phenelzine, and isocarboxazide.

Trophic factors are factors whose continued presence improves the viability or longevity of a cell trophic factors include, without limitation, platelet-derived growth factor (PDGP), neutrophil-activating protein, monocyte chemoattractant protein, macrophage-inflammatory protein, platelet factor, platelet basic protein, and melanoma growth stimulating activity; epidermal growth factor, transforming growth factor (alpha), fibroblast growth factor, platelet-derived endothelial cell growth factor, insulin-like growth factor, glial derived growth neurotrophic factor, ciliary neurotrophic factor, nerve growth factor, bone growth/cartilage-inducing factor (alpha and beta), bone morphogenetic proteins, interleukins (e.g., interleukin inhibitors or interleukin receptors, including interleukin 1 through interleukin 10), interferons (e.g., interferon alpha, beta and gamma), hematopoietic factors, including erythropoietin, granulocyte colony stimulating factor, macrophage colony stimulating factor and granulocyte-macrophage colony stimulating factor; tumor necrosis factors, and transforming growth factors (beta), including beta-1, beta-2, beta-3, inhibin, and activin.

Hormones include estrogens (e.g., estradiol, estrone, estriol, diethylstibestrol, quinestrol, chlorotrianisene, ethinyl estradiol, mestranol), anti-estrogens (e.g., clomiphene, tamoxifen), progestins (e.g., medroxyprogesterone, norethindrone, hydroxyprogesterone, norgestrel), antiprogestin (mifepristone), androgens (e.g, testosterone cypionate, fluoxymesterone, danazol, testolactone), anti-androgens (e.g., cyproterone acetate, flutamide), thyroid hormones (e.g., triiodothyronne, thyroxine, propylthiouracil, methimazole, and iodixode), and pituitary hormones (e.g., corticotropin, sumutotropin, oxytocin, and vasopressin). Hormones are commonly employed in hormone replacement therapy and/or for purposes of birth control. Steroid hormones, such as prednisone, are also used as immunosuppressants and anti-inflammatoires. In some aspects, the additive is an agent that stimulates tissue formation, and/or healing and regrowth of natural tissues, and any combinations thereof. Agents that increase formation of new tissues and/or stimulates healing or regrowth of native tissue at the site of injection can include, but are not limited to, fibroblast growth factor (FGF), transforming growth factor-beta (TGF-beta, platelet-derived growth factor (PDGF), epidermal growth factors (EGFs), connective tissue activated peptides (CTAPs), osteogenic factors including bone morphogenic proteins, heparin, angiotensin II (A-II) and fragments thereof, insulin-like growth factors, tumor necrosis factors, interleukins, colony stimulating factors, erythropoietin, nerve growth factors, interferons, biologically active analogs, fragments, and derivatives of such growth factors, and any combinations thereof.

In some aspects, the silk composition can further comprise at least one additional material for soft tissue augmentation, e.g., dermal filler materials, including, but not limited to, poly(methyl methacrylate) microspheres, hydroxylapatite, poly(L-lactic acid), collagen, elastin, and glycosaminoglycans, hyaluronic acid, commercial dermal filler products such as BOTOX® (from Allergan), DYSPORT®, COSMODERM®, EVOLENCE®, RADIESSE®,RESTYLANE®, JUVEDERM® (from Allergan), SCULPTRA®, PERLANE®, and CAPTIQEIER, and any combinations thereof.

In some aspects, the additive is a wound healing agent. As used herein, a “wound healing agent” is a compound or composition that actively promotes wound healing process.

Exemplary wound healing agents include, but are not limited to dexpanthenol; growth factors; enzymes, hormones; povidon-iodide; fatty acids; anti-inflammatory agents; antibiotics; antimicrobials; antiseptics; cytokines; thrombin; angalgesics; opioids; aminoxyls; furoxans; nitrosothiols; nitrates and anthocyanins; nucleosides, such as adenosine; and nucleotides, such as adenosine diphosphate (ADP) and adenosine triphosphate (ATP); neutotransmitter/neuromodulators, such as acetylcholine and 5-hydroxytryptamine (serotonin/5-HT); histamine and catecholamines, such as adrenalin and noradrenalin; lipid molecules, such as 5 sphingosine-1-phosphate and lysophosphatidic acid; amino acids, such as arginine and lysine; peptides such as the bradykinins, substance P and calcium gene-related peptide (CGRP); nitric oxide; and any combinations thereof.

In certain aspects, the active agents provided herein are immunogens. In one aspect, the immunogen is a vaccine. Most vaccines are sensitive to environmental conditions under which they are stored and/or transported. For example, freezing may increase reactogenicity (e.g., capability of causing an immunological reaction) and/or loss of potency for some vaccines (e.g., HepB, and DTaP/IPV/FQB), or cause hairline cracks in the container, leading to contamination. Further, some vaccines (e.g., BCG, Varicella, and MMR) are sensitive to heat. Many vaccines (e.g., BCG, MMR, Varicella, Meningococcal C Conjugate, and most DTaP-containing vaccines) are light sensitive. See, e.g., Galazka et al., Thermostability of vaccines, in Global Programme for Vaccines & Immunization (World Health Organization, Geneva, 1998); Peetermans et al., Stability of freeze-dried rubella virus vaccine (Cendehill strain) at various temperatures, 1 J. Biological Standardization 179 (1973). Thus, the compositions and methods provided herein also provide for stabilization of vaccines regardless of the cold chain and/or other environmental conditions.

In some aspects, the additive is a cell, e.g., a biological cell. Cells useful for incorporation into the composition can come from any source, e.g., mammalian, insect, plant, etc. In some aspects, the cell can be a human, rat or mouse cell. In general, cells to be used with the compositions provided herein can be any types of cells. In general, the cells should be viable when encapsulated within compositions. In some aspects, cells that can be used with the composition include, but are not limited to, mammalian cells (e.g. human cells, primate cells, mammalian cells, rodent cells, etc.), avian cells, fish cells, insect cells, plant cells, fungal cells, spore cells, bacterial cells, and hybrid cells. In some aspects, exemplary cells that can be can be used with the compositions include platelets, activated platelets, stem cells, totipotent cells, pluripotent cells, and/or embryonic stem cells. In some aspects, exemplary cells that can be encapsulated within compositions include, but are not limited to, primary cells and/or cell lines from any tissue. For example, cardiomyocytes, myocytes, hepatocytes, keratinocytes, melanocytes, neurons, astrocytes, embryonic stem cells, adult stem cells, hematopoietic stem cells, hematopoietic cells (e.g. monocytes, neutrophils, macrophages, etc.), ameloblasts, fibroblasts, chondrocytes, osteoblasts, osteoclasts, neurons, sperm cells, egg cells, liver cells, epithelial cells from lung, epithelial cells from gut, epithelial cells from intestine, liver, epithelial cells from skin, etc., and/or hybrids thereof, can be included in the silk/platelet compositions disclosed herein. Those skilled in the art will recognize that the cells listed herein represent an exemplary, not comprehensive, list of cells. Cells can be obtained from donors (allogenic) or from recipients (autologous). Cells can be obtained, as a non-limiting example, by biopsy or other surgical means known to those skilled in the art.

In some aspects, the cell can be a genetically modified cell. A cell can be genetically modified to express and secrete a desired compound, e.g. a bioactive agent, a growth factor, differentiation factor, cytokines, and the like. Methods of genetically modifying cells for expressing and secreting compounds of interest are known in the art and easily adaptable by one of skill in the art.

Differentiated cells that have been reprogrammed into stem cells can also be used.

For example, human skin cells reprogrammed into embryonic stem cells by the transduction of Oct3/4, Sox2, c-Myc and Klf4 (Junying Yu, et. ah, Science, 2007, 318, 1917-1920 and Takahashi K. et. ah, Cell, 2007, 131, 1-12).

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, any of the features or functions of any of the embodiments disclosed herein may be incorporated into any of the other embodiments disclosed herein.

### EXAMPLES

### Example 1

One exemplary procedure for making an article using a single biopolymer to produce a highly uniform article is described. The following steps were performed: 1) a 25 wt % silk solution was prepared according to previously reported methods (Rockwood, D., Preda, R., Yücel, T. et al. Materials fabrication from Bombyx mori silk fibroin. Nat Protoc 6, 1612-1631 (2011)) and stored in a syringe taking care to reduce or eliminate the presence of air bubbles; 2) prepare a 4M NaCL and a 0.5 M potassium phosphate dibasic solution; 3) deposit 1.5 mL of the silk solution into the mold; 4) centrifuge the mold and its contents at 2000×g for 3 minutes to force the silk solution to conform to the mold negative and fill any space vacancies; 5) deposit 1.5 mL of the ionic solution atop the silk solution, careful not to disturb the settled layer, and wait for the polymerization to begin; 6) centrifuge the mold and its content at 2000×g for 3 minutes to drive the polymerization/bath penetration and to force the solution to conform to the mold negative, compensating for any shrinkage and geometric variation that occurs during solidification; 7) gently aspirate the supernatant and polymerization solution, careful not to disturb the polymerizing silk; 8) verify that the silk solution has not fully polymerized (can be visually observed by color transition from yellow to white, though other methods are known-if the previously-deposited layer is too polymerized, then undesirable distinct layers form; 9) repeat steps 3-8) until the mold is filled; and 10) deposit the ionic solution on top of the mold and let it sit for 24 hours to fully polymerize.

The amount of material deposited and the number of cycles can be tailored for specific material and volume requirements.

The article had desirable material properties. The material is very strong, bulk, and homogeneous. The article can be used for bone applications, because it is strong relative to other silk techniques, but it is also more elastic than thermo-processed silk, so it possesses multiple advantages over previous methods.

### Example 2

One exemplary procedure for making an article using two different biopolymers to produce a highly uniform article is described. The following steps were performed: 1) 1.5 mL of chitosan dissolved in acetic acid was introduced into a mold; 2) the mold and its contents were centrifuged at 2000×g for 3 minutes for the chitosan solution to conform to the mold negative; 3) deposit 1.5 mL of 5% NaOH and 70% ethanol solution into the mold to start the polymerization process; 4) centrifuge the mold and its contents and 2000×g for 3 minutes to drive the polymerization process and to force the solution to conform to the mold negative, compensating for any shrinkage and geometric variation that occurs during solidification; 5) let the mold sit until polymerization of chitosan is complete (24 hours); 6) wash the polymerized chitosan and the interior of the mold repeatedly with water (preferably DI water) to clean out residual NaOH; 7) deposit 1.5 mL of the above-referenced silk solution into the mold, directly atop the chitosan; 8) centrifuge the mold and its contents at 2000×g for 3 minutes to force the silk solution to conform to the mold negative and fill any space vacancies; 9) deposit 1.5 mL of the above-referenced ionic solution atop the silk solution, careful not to disturb the settled layer, thereby starting crystallization of the silk; centrifuge the mold and its contents at 2000×g for 3 minutes to drive polymerization/bath penetration and to force the solution to conform to the mold negative, compensating for any shrinkage and geometric variation that occurs during solidification; 11) let the mold sit until complete polymerization of the silk (24 hours).

As with Example 1, the amount of material deposited and the number of cycles can be tailored for specific material and volume requirements.

The article had desirable material properties. The article exhibited a duality of material properties, most notably the strength and robustness of the silk, but dissolvability facilitated by the separate layer of chitosan.

### Example 3

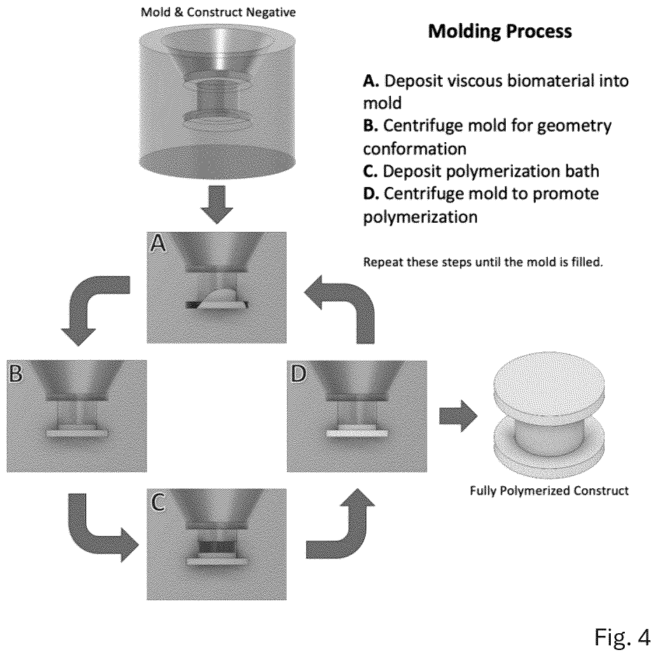

Referring to FIG. 4, first, the biopolymer solution is deposited into the predesigned mold. Centrifugal force is used to drive the viscous bioinks to conform to the mold negative-adapting into any geometry desired. Then, the polymerization bath/agent is deposited topically onto the centrifuged biopolymer later and the mold is centrifuged again. Centrifuging the polymerization agent and polymer together drives polymerization through the forces of compression and from the centrifugal force causing the agents of the polymerization bath to penetrate the biopolymer layer. The centrifugal force applied and time for each step, conforming the biopolymer and inducing polymerization with the salt bath is optimized specifically for each material and method of polymerization. After centrifuging with the polymerization bath, the supernatant and polymerization bath are aspirated out. Extra solution may be removed from the mold because there will be a tendency for a liquid or air pocket to form when the next layer of biopolymer is deposited topically. This may compromise the structural integrity of the molded constructs. The steps are repeated until the mold has been filled. In some embodiments, the mold is filled to excess and then shaved of any excess material.

Multi-Material Constructs: Disclosed herein are systems and methods to create constructs with distinct and composite layers. This can be controlled by the degree of polymerization of the subsequent layer. There is a combination of materials that can be incorporated into a single mold. Silk and chitosan can adhere to each other to form a compound structure with distinct layers because silk has a negative charge and chitosan has a positive charge. After the deposition of the previous material, the supernatant and the previous polymerization bath may be aspirated through normal use. Then, the molding process with the next desired material is repeated through the same steps.

Solvent Bath Additives: This method can be used to incorporate additives into material layers as the centrifugal forces promote the penetration of any materials into the previous layer. Many times, this will be controlled by the density and force applied of the additives within the solution and the degree of polymerization of the previous layer.

### Example 4

One exemplary procedure for making an article using chitosan to produce a highly uniform article is described. The following steps were performed: 1) chitosan dissolved in acetic acid is introduced into a mold; 2) the mold and its contents are centrifuged, such as at 2000×g for 3 minutes for the chitosan solution to conform to the mold negative; 3) deposit a NaOH and ethanol solution into the mold to start the polymerization process; 4) centrifuge the mold and its contents to drive the polymerization process and to force the solution to conform to the mold negative, compensating for any shrinkage and geometric variation that occurs during solidification; 5) let the mold sit until polymerization of chitosan is complete (e.g., 24 hours); 6) wash the polymerized chitosan and the interior of the mold repeatedly with water (preferably DI water) to clean out residual NaOH. The amount of material deposited and the number of cycles of steps 1-6 may be repeated and/or tailored for specific material and volume requirements.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

In addition to the features described above and elsewhere herein, the present disclosure also includes the following clauses:

1. A controlled centrifugal solidification biopolymer article, wherein the article is not a film, wherein at least a portion of the article comprises at least one characteristic centrifugal property selected from the group consisting of:
i) a uniform density across the at least a portion of the article;
ii) the at least a portion of the article is optically nontransparent;
iii) the at least a portion of the article is free of exterior layering;
iv) the at least a portion of the article is free of interior layering;
v) the at least a portion of the article is interior-void-free;
vi) the at least a portion of the article is free of cylindrical extrusion gaps; and
vii) the at least a portion of the article is free of layering.
   2. The controlled centrifugal solidification biopolymer article of clause 1, wherein the at least one characteristic centrifugal property includes i) the uniform density across the at least a portion of the article.
   3. The controlled centrifugal solidification biopolymer article of clause 1 or 2, wherein the at least one characteristic centrifugal property includes ii) the at least a portion of the article is optically nontransparent.
   4. The controlled centrifugal solidification biopolymer article of any one of the preceding clauses, wherein the at least one characteristic centrifugal property includes iii) the at least a portion of the article is free of exterior layering.
   5. The controlled centrifugal solidification biopolymer article of any one of the preceding clauses, wherein the at least one characteristic centrifugal property includes iv) the at least a portion of the article is free of interior layering.
   6. The controlled centrifugal solidification biopolymer article of any one of the preceding clauses, wherein the at least one characteristic centrifugal property includes v) the at least a portion of the article is interior-void-free.
   7. The controlled centrifugal solidification biopolymer article of any one of the preceding clauses, wherein the at least one characteristic centrifugal property includes vi) the at least a portion of the article is free of cylindrical extrusion gaps.
   8. The controlled centrifugal solidification biopolymer article of any one of the preceding clauses, wherein the at least one characteristic centrifugal property includes vii) the at least a portion of the article is free of layering.
   9. The controlled centrifugal solidification biopolymer article of any one of the preceding clauses, the article comprising at least two, at least three, at least four, at least five, at least six, or at least seven of the at least one characteristic centrifugal property selected from the group consisting of:
i) a uniform density across the at least a portion of the article;
ii) the at least a portion of the article is optically nontransparent;
iii) the at least a portion of the article is free of exterior layering;
iv) the at least a portion of the article is free of interior layering;
v) the at least a portion of the article is interior-void-free;
vi) the at least a portion of the article is free of cylindrical extrusion gaps; and
vii) the at least a portion of the article is free of layering.
   10. A method of centrifugal controlled biosolidification molding, the method comprising the following sequential steps:
A) introducing a first aqueous biopolymer solution into a mold and optionally settling the first aqueous biopolymer solution into the mold;
B) introducing a first aqueous curing solution into the mold atop the first aqueous biopolymer solution and optionally settling the first aqueous curing solution into the mold, wherein the mold has a first orientation relative to gravity during step B); and
C) subjecting the mold and contents of the mold to a first centrifugation and stopping after a first centrifugation length of time, thereby producing a first biosolidifying body, wherein the mold is within 45° of the first orientation relative to the first centrifugation during step C);
wherein waiting a first final biosolidification length of time following step C) produces a first biopolymer article from the first biosolidifying body.
   11. The method of clause 10, wherein step A) includes settling the first aqueous biopolymer solution into the mold.
   12. The method of clause 11, wherein settling comprises subjecting the mold and the contents of the mold to a settling centrifugation and stopping after a settling centrifugation length of time, thereby conforming the first biopolymer solution to geometry of the mold, wherein the mold is within 45° of the first orientation relative to the first centrifugation during step B) during the settling centrifugation.
   13. The method of clause 11, wherein settling comprises tapping the mold and the contents of the mold on a surface, thereby conforming the first biopolymer solution to geometry of the mold, wherein the mold is within 45° of the first orientation relative to the first centrifugation during step B) during the tapping.
   14. The method of clause 10, the method further comprising waiting the first final biosolidification length of time following step C), thereby producing the first biopolymer article.
   15. The method of clause 10, wherein the first aqueous biopolymer solution is an aqueous silk solution, an aqueous alginate solution, an aqueous fibrinogen solution, an aqueous chitosan solution, an aqueous collagen solution, or a combination thereof.
   16. The method of clause 15, wherein the first aqueous biopolymer solution is the aqueous silk solution and the first aqueous curing solution is an aqueous silk crosslinking and/or hydrogel initiating solution.
   17. The method of clause 15, wherein the first aqueous biopolymer solution is the aqueous alginate solution and the first aqueous curing solution is an aqueous alginate crosslinking solution.
   18. The method of clause 15, wherein the first aqueous biopolymer solution is the aqueous fibrinogen solution and the first aqueous curing solution is an aqueous fibrinogen curing solution.
   19. The method of clause 15, wherein the first aqueous biopolymer solution is the aqueous collagen solution and the first aqueous curing solution is an aqueous collagen curing solution.
   20. The method of clause 15, wherein the first aqueous biopolymer solution is the aqueous chitosan solution and the first aqueous curing solution is an aqueous chitosan curing solution.
   21. The method of the immediately preceding clause, wherein the aqueous chitosan curing solution is sodium hydroxide, ethanol, or a combination thereof.
   22. The method of clause 10, the method further comprising the following sequential steps:
D) introducing a second aqueous biopolymer solution into the mold atop the first biosolidifying body and optionally settling the second aqueous biopolymer solution into the mold;
E) introducing a second aqueous curing solution into the mold atop the second aqueous biopolymer solution and optionally settling the second aqueous curing solution into the mold, wherein the mold has a second orientation relative to gravity during step E); and
F) subjecting the mold and contents of the mold to a second centrifugation and stopping after a second centrifugation length of time, thereby producing a second biosolidifying body inclusive of the first biosolidifying body, wherein the mold is within 45° of the second orientation relative to the second centrifugation in step F),
   wherein waiting a second final biosolidification length of time following step F) produces a second biopolymer article from the second biosolidifying body.
   23. The method of clause 22, the method further comprising waiting the second final biosolidication length of time following step F), thereby producing the second biopolymer article.
   24. The method of clause 22, wherein the second orientation is the same as the first orientation.
   25. The method of clause 22, wherein the second orientation is different than the first orientation.
   26. The method of clause 22, the method further comprising the following steps:
G) introducing a third aqueous biopolymer solution into the mold atop the second biosolidifying body and optionally settling the third aqueous biopolymer solution into the mold;
H) introducing a third aqueous curing solution into the mold atop the third aqueous biopolymer solution and optionally settling the third aqueous curing solution into the mold, wherein the mold has a third orientation relative to gravity during step H); and
I) subjecting the mold and contents of the mold to a third centrifugation and stopping after a third centrifugation length of time, thereby producing a third biosolidifying body inclusive of the first and second biosolidifying bodies, wherein the mold is within 45° of the third orientation relative to the third centrifugation during step I),
   wherein waiting a third final biosolidifcation length of time following step I) produces a third biopolymer article from the third biosolidifying body.
   27. The method of clause 26, the method further comprising waiting the third final solidification length of time following step I), thereby producing the third biopolymer article.
   28. The method of clause 26, the method further comprising the following sequential steps:
J) introducing a fourth aqueous biopolymer solution into the mold atop the third biosolidifying body and optionally settling the fourth aqueous biopolymer solution into the mold;
K) introducing a fourth aqueous curing solution into the mold atop the fourth aqueous biopolymer solution and optionally settling the fourth aqueous curing solution into the mold, wherein the mold has a fourth orientation relative to gravity during step J); and
L) subjecting the mold and contents of the mold to a fourth centrifugation and stopping after a fourth centrifugation length of time, thereby producing a fourth biosolidifying body inclusive of the first, second, and third biosolidifying bodies, wherein the mold is within 45° of the fourth orientation relative to the fourth centrifugation during step L),
   wherein waiting a fourth final biosolidifcation length of time following step L) produces a fourth biopolymer article from the fourth biosolidifying body.
   29. The method of clause 28, the method further comprising waiting the third final solidification length of time following step L), thereby producing the third biopolymer article.
   30. The method of any one of clauses 10 to the immediately preceding clause, the method further comprising the following sequential steps:
X) introducing an additional aqueous biopolymer solution atop existing portions of a biosolidifying body and optionally settling the additional aqueous biopolymer solution into the mold, the existing portions of the biosolidifying body inclusive of the first biosolidifying body and optionally inclusive of the second, third, and fourth biosolidifying bodies;
Y) introducing an additional aqueous curing solution into the mold atop the additional aqueous biopolymer solution and optionally settling the additional aqueous curing solution into the mold; and
Z) subjecting the mold and the contents of the mold to an additional centrifugation and stopping after an additional centrifugal length of time, thereby producing an additional biosolidifying body inclusive of the existing portions of the biosolidifying body,
   wherein waiting an additional final biosolidification length of time following step Z) producing an additional biopolymer article from the additional biosolidifying body.
   31. The method of clause 30, the method further comprising waiting the additional final solidification length of time following step Z), thereby producing the additional biopolymer article.
   32. A method of making a biopolymer article, the method comprising at least two iterative cycles of the following steps:
X) introducing an iterative aqueous biopolymer solution into a mold and optionally settling the iterative aqueous biopolymer solution into the mold;
Y) introducing an iterative aqueous curing solution into the mold atop the iterative aqueous biopolymer solution and optionally settling the iterative aqueous curing solution into the mold; and
Z) subjecting the mold and the contents of the mold to an iterative centrifugation and stopping after an iterative centrifugal length of time, thereby iteratively adding to existing portions of the solidifying body, the iteratively introducing of step X), introducing of step Y), and subjecting of step Z) continuing until a final biosolidifying body is formed, wherein waiting a final biosolidification length of time following formation of the final biosolidification body produces the biopolymer article.
   33. The method of clause 32, the method further comprising waiting the final biosolidification length of time following step Z), thereby producing the biopolymer article.
   34. A method comprising:

centrifuging a first early-stage-of-solidification aqueous biopolymer solution within a mold until a first later stage of solidification, thereby forming a first biosolidifying body.

35. The method of clause 34, the method further comprising centrifuging a second early-stage-of-solidification aqueous biopolymer solution within the mold atop the first biosolidifying body until a second later stage of solidification, thereby forming a second biosolidifying body inclusive of the first biosolidifying body.
36. The method of any one of clauses 10 to the immediately preceding clause, wherein the mold is three-dimensional printed.
37. The method of any one of clauses 10 to the immediately preceding clause, wherein the method comprising three-dimensional printing the mold prior to step A).
38. The method of any one of clauses 10 to the immediately preceding clause, wherein sacrificial molding is used during the method.
39. The method of the immediately preceding clause, wherein the sacrificial molding is acrylonitrile butadiene styrene.
40. The method of the immediately preceding clause, wherein the method includes removing the sacrificial molding using acetone or an alcohol.
41. The method of any one of clauses 10 to the immediately preceding clause, wherein a top mold is present during one or more centrifugation step, thereby introducing additional molding to one or more of the biosolidifying articles.
42. The method of any one of clauses 10 to the immediately preceding clause, wherein a first biopolymer of the first aqueous biopolymer solution, a second biopolymer of the second biopolymer solution, a third biopolymer of the third biopolymer solution, a fourth biopolymer of the fourth biopolymer solution, and/or an iterative biopolymer of the iterative biopolymer solution is selected from the group consisting of silk fibroin, alginate, fibrinogen, chitosan, collagen, and combinations thereof.
43. The method of clause 42, wherein the first, second, third, fourth, and/or iterative biopolymer is silk fibroin.
44. The method of the immediately preceding clause, wherein the first, second, third, fourth, and/or iterative curing solution is a beta sheet initiation or hydrogel initiation composition.
45. The method of clause 42, wherein the first, second, third, fourth, and/or iterative biopolymer is alginate.
46. The method of the immediately preceding clause, wherein the first, second, third, fourth, and/or iterative curing solution is a calcium ion solution.
47. The method of clause 42, wherein the first, second, third, fourth, and/or iterative biopolymer is fibrinogen.
48. The method of the immediately preceding clause, wherein the first, second, third, fourth, and/or iterative curing solution is a thrombin solution that cleaves and polymerizes fibrinogen into fibrin.
49. The method of clause 42, wherein the first, second, third, fourth, and/or iterative biopolymer is chitosan.
50. The method of the immediately preceding clause, the chitosan is acidic, wherein the first, second, third, fourth, and/or iterative curing solution is a neutralizing agent that neutralizes the acid and solidifies the chitosan.
51. The method of the immediately preceding clause, wherein the first, second, third, fourth, and/or iterative curing solution is at least one of sodium hydroxide, a mixture of sodium hydroxide and ethanol, ethanol, urea (carbamide), carbonic acid, or sodium tripolyphosphate.
52. The method of clause 42, wherein the first, second, third, fourth, and/or iterative biopolymer is collagen.
53. The method of the immediately preceding clause, the collagen is acidic, wherein the first, second, third, fourth, and/or iterative curing solution is a pH adjusting agent that directs collagen self-assembly.
54. The method of any one of clauses 10 to the immediately preceding clause, the method further comprising chemically cross-linking the first, second, third, fourth, or final biosolidifying body or the first, second, third, fourth, or final biopolymer article.
55. The method of any one of clauses 10 to the immediately preceding clause, the method further comprising physically cross-linking the first, second, third, fourth, or final biosolidifying body or the first, second, third, fourth, or final biopolymer article.
56. The method of any one of clauses 10 to the immediately preceding clause, the method further comprising chemically etching the first, second, third, fourth, or final biosolidifying body or the first, second, third, fourth, or final biopolymer article.
57. The method of any one of clauses 10 to the immediately preceding clause, the method further comprising chemically smoothing the first, second, third, fourth, or final biosolidifying body or the first, second, third, fourth, or final biopolymer article.
58. The method of any one of clauses 10 to the immediately preceding clause, the method further comprising chain extending and/or branching polymers in the first, second, third, fourth, or final biosolidifying body or the first, second, third, fourth, or final biopolymer article.
59. The method of any one of clauses 10 to the immediately preceding clause, the method further comprising chemically functionalizing the first, second, third, fourth, or final biosolidifying body or the first, second, third, fourth, or final biopolymer article.
60. The method of any one of clauses 10 to the immediately preceding clause, the method further comprising degassing the first, second, third, fourth, and/or iterative aqueous biopolymer solution and/or the first, second, third, fourth, and/or iterative aqueous curing solution.
61. The method of any one of clauses 10 to the immediately preceding clause, wherein the first, second, third, fourth, and/or iterative aqueous biopolymer solution and/or the first, second, third, fourth, and/or iterative aqueous curing solution further comprises an additive.
62. The method of clause 61, wherein the first aqueous biopolymer solution comprises the additive.
63. The method of clause 61, wherein the second aqueous biopolymer solution comprises the additive.
64. The method of clause 61, wherein the third aqueous biopolymer solution comprises the additive.
65. The method of clause 61, wherein the fourth aqueous biopolymer solution comprises the additive.
66. The method of clause 61, wherein the iterative aqueous biopolymer solution comprises the additive.
67. The method of clause 61, wherein the first aqueous curing solution comprises the additive.
68. The method of clause 61, wherein the second aqueous curing solution comprises the additive.
69. The method of clause 61, wherein the third aqueous curing solution comprises the additive.
70. The method of clause 61, wherein the fourth aqueous curing solution comprises the additive.
71. The method of clause 61, wherein the iterative aqueous curing solution comprises the additive.
72. The method of any one of clauses 61 to 71, wherein the additive comprises nanoparticles.
73. The method of any one of clauses 61 to 71, wherein the additive comprises a structural altering material.
74. The method of any one of clauses 61 to 71, wherein the additive comprises a bioactive material.
75. The method of any one of the preceding clauses, wherein the mold, prior to introducing the first, second, third, fourth, and/or iterative aqueous biopolymer solution and/or the first, second, third, fourth, and/or iterative aqueous curing solution into the mold, contains a structural altering material.
76. The method of clause 73 or 75, wherein the structural altering material comprises fibers.
77. The method of clause 73 or 75, wherein the structural altering material comprises fabric.
78. The method of clause 73 or 75, wherein the structural altering material comprises a scaffold.
79. The method of clause 73 or 75, wherein the structural altering material comprises a foam.
80. The method of clause 73 or 75, wherein the structural altering material comprises a plasticizer.
81. The method of clause 73 or 75, wherein the structural altering material comprises a porogen.
82. The method of any one of the preceding clauses, wherein the mold, prior to introducing the first, second, third, fourth, and/or iterative aqueous biopolymer solution and/or the first, second, third, fourth, and/or iterative aqueous curing solution into the mold, contains nanoparticles.
83. The method of clause 72 or 82, wherein the nanoparticles comprise silk nanoparticles.
84. The method of clause 72 or 82, wherein the nanoparticles comprise metal nanoparticles.
85. The method of clause 72 or 82, wherein the nanoparticles comprise semiconductor nanoparticles.
86. The method of any one of the preceding clauses, wherein the mold, prior to introducing the first, second, third, fourth, and/or iterative aqueous biopolymer solution and/or the first, second, third, fourth, and/or iterative aqueous curing solution into the mold, contains bioactive material.
87. The method of clause 74 or 86, wherein the bioactive material comprises one or more cells.
88. The method of clause 74 or 86, wherein the bioactive material comprises one or more growth factors.
89. An article made by the method of any one of clauses 10 to the immediately preceding clause.
90. The article of the immediately preceding clause, wherein the article is at least a portion of a medical device.
91. The article of the immediately preceding clause, wherein the article or the medical device is a catheter, a stent, an ear tube, a septal button, a nerve capping device, a Kirshner wire, an artificial lens, a dental implant, a bone scaffold, a spinal implant, a plate, a screw, a pin, a rod, or a combination thereof.
92. A controlled centrifugal solidification chitosan article, wherein the article is not a film, wherein at least a portion of the article comprises at least one characteristic centrifugal property selected from the group consisting of:
i) a uniform density across the at least a portion of the article;
ii) the at least a portion of the article is optically nontransparent;
iii) the at least a portion of the article is free of exterior layering;
iv) the at least a portion of the article is free of interior layering;
v) the at least a portion of the article is interior-void-free;
vi) the at least a portion of the article is free of cylindrical extrusion gaps; and
vii) the at least a portion of the article is free of layering.
   93. A method of centrifugal controlled chitosan biosolidification molding, the method comprising the following sequential steps:
A) introducing a chitosan solution into a mold and optionally settling the chitosan solution into the mold;
B) introducing a chitosan curing solution into the mold atop the chitosan solution and optionally settling the chitosan curing solution into the mold, wherein the mold has a first orientation relative to gravity during step B); and
C) subjecting the mold and contents of the mold to a first centrifugation and stopping after a first centrifugation length of time, thereby producing a first biosolidifying body, wherein the mold is within 45° of the first orientation relative to the first centrifugation during step C);
wherein waiting a first final biosolidification length of time following step C) produces a first biopolymer article from the first biosolidifying body.
   94. The method of clause 93, wherein settling comprises subjecting the mold and the contents of the mold to a settling centrifugation and stopping after a settling centrifugation length of time, thereby conforming the chitosan solution to geometry of the mold, wherein the mold is within 45° of the first orientation relative to the first centrifugation during step B) during the settling centrifugation.
   95. The method of clause 93, wherein settling comprises tapping the mold and the contents of the mold on a surface, thereby conforming the chitosan solution to geometry of the mold, wherein the mold is within 45° of the first orientation relative to the first centrifugation during step B) during the tapping.
   96. The method of clause 93, the method further comprising waiting the first final biosolidification length of time following step C), thereby producing the first biopolymer article.
   97. The method of clause 93, wherein the aqueous chitosan curing solution is sodium hydroxide, ethanol, or a combination thereof.
   98. The method of clause 93, the method further comprising the following sequential steps:
D) introducing a second aqueous biopolymer solution into the mold atop the first biosolidifying body and optionally settling the second aqueous biopolymer solution into the mold;
E) introducing a second aqueous curing solution into the mold atop the second aqueous biopolymer solution and optionally settling the second aqueous curing solution into the mold, wherein the mold has a second orientation relative to gravity during step E); and
F) subjecting the mold and contents of the mold to a second centrifugation and stopping after a second centrifugation length of time, thereby producing a second biosolidifying body inclusive of the first biosolidifying body, wherein the mold is within 45° of the second orientation relative to the second centrifugation in step F),
   wherein waiting a second final biosolidification length of time following step F) produces a second biopolymer article from the second biosolidifying body.
   99. The method of clause 98, the method further comprising waiting the second final biosolidication length of time following step F), thereby producing the second biopolymer article.
   100. The method of clause 98, wherein the second orientation is the same as the first orientation.
   101. The method of clause 98, wherein the second orientation is different than the first orientation.
   102. The method of clause 98, the method further comprising the following steps:
G) introducing a third aqueous biopolymer solution into the mold atop the second biosolidifying body and optionally settling the third aqueous biopolymer solution into the mold;
H) introducing a third aqueous curing solution into the mold atop the third aqueous biopolymer solution and optionally settling the third aqueous curing solution into the mold, wherein the mold has a third orientation relative to gravity during step H); and
I) subjecting the mold and contents of the mold to a third centrifugation and stopping after a third centrifugation length of time, thereby producing a third biosolidifying body inclusive of the first and second biosolidifying bodies, wherein the mold is within 45° of the third orientation relative to the third centrifugation during step I),
   wherein waiting a third final biosolidifcation length of time following step I) produces a third biopolymer article from the third biosolidifying body.
   103. The method of clause 102, the method further comprising waiting the third final solidification length of time following step I), thereby producing the third biopolymer article.
   104. The method of clause 102, the method further comprising the following sequential steps:
J) introducing a fourth aqueous biopolymer solution into the mold atop the third biosolidifying body and optionally settling the fourth aqueous biopolymer solution into the mold;
K) introducing a fourth aqueous curing solution into the mold atop the fourth aqueous biopolymer solution and optionally settling the fourth aqueous curing solution into the mold, wherein the mold has a fourth orientation relative to gravity during step J); and
L) subjecting the mold and contents of the mold to a fourth centrifugation and stopping after a fourth centrifugation length of time, thereby producing a fourth biosolidifying body inclusive of the first, second, and third biosolidifying bodies, wherein the mold is within 45° of the fourth orientation relative to the fourth centrifugation during step L),
   wherein waiting a fourth final biosolidifcation length of time following step L) produces a fourth biopolymer article from the fourth biosolidifying body.
   105. The method of clause 104, the method further comprising waiting the third final solidification length of time following step L), thereby producing the third biopolymer article.
   106. The method of any one of clauses 93 to the immediately preceding clause, the method further comprising the following sequential steps:
X) introducing an additional aqueous biopolymer solution atop existing portions of a biosolidifying body and optionally settling the additional aqueous biopolymer solution into the mold, the existing portions of the biosolidifying body inclusive of the first biosolidifying body and optionally inclusive of the second, third, and fourth biosolidifying bodies;
Y) introducing an additional aqueous curing solution into the mold atop the additional aqueous biopolymer solution and optionally settling the additional aqueous curing solution into the mold; and
Z) subjecting the mold and the contents of the mold to an additional centrifugation and stopping after an additional centrifugal length of time, thereby producing an additional biosolidifying body inclusive of the existing portions of the biosolidifying body,
   wherein waiting an additional final biosolidification length of time following step Z) producing an additional biopolymer article from the additional biosolidifying body.
   107. The method of clause 106, the method further comprising waiting the additional final solidification length of time following step Z), thereby producing the additional biopolymer article.
   108. The method of any of clauses 93 to the immediately preceding clause, wherein the second, third, or fourth aqueous biopolymer solution is an aqueous silk solution, an aqueous alginate solution, an aqueous fibrinogen solution, an aqueous chitosan solution, an aqueous collagen solution, or a combination thereof.
   109. The method of clause 108, wherein the second, third, fourth, or additional aqueous biopolymer solution is the aqueous silk solution and the corresponding second, third, fourth, or additional aqueous curing solution is an aqueous silk crosslinking and/or hydrogel initiating solution.
   110. The method of clause 108, wherein the second, third, fourth, or additional aqueous biopolymer solution is the aqueous alginate solution and the second, third, fourth, or additional aqueous curing solution is an aqueous alginate crosslinking solution.
   111. The method of clause 108, wherein the second, third, fourth, or additional aqueous biopolymer solution is the aqueous fibrinogen solution and the second, third, fourth, or additional aqueous curing solution is an aqueous fibrinogen curing solution.
   112. The method of clause 108, wherein the second, third, fourth, or additional aqueous biopolymer solution is the aqueous collagen solution and the second, third, fourth, or additional aqueous curing solution is an aqueous collagen curing solution.
   113. The method of clause 108, wherein the second, third, fourth, or additional aqueous biopolymer solution is the aqueous chitosan solution and the second, third, fourth, or additional aqueous curing solution is an aqueous chitosan curing solution.
   114. The method of the immediately preceding clause, wherein the aqueous chitosan curing solution is sodium hydroxide, ethanol, or a combination thereof.
   115. The method of any one of clauses 93 to the immediately preceding clause, wherein sacrificial molding is used during the method.
   116. The method of the immediately preceding clause, wherein the sacrificial molding is acrylonitrile butadiene styrene.
   117. The method of the immediately preceding clause, wherein the method includes removing the sacrificial molding using acetone or an alcohol.
   118. The method of any one of clauses 93 to the immediately preceding clause, wherein the chitosan, second, third, fourth, and/or additional aqueous biopolymer solution and/or the chitosan, second, third, fourth, and/or additional aqueous curing solution further comprises an additive.
   119. The method of the immediately preceding clause, wherein the additive comprises nanoparticles, a structural altering material, or a bioactive material.

1. (canceled)

2. A method of producing a first biopolymer article, the method comprising the following sequential steps:
A) introducing a first biopolymer solution into a mold and optionally settling the first biopolymer solution into the mold;
B) introducing a first aqueous-curing solution into the mold atop the first biopolymer solution and optionally settling the first curing solution into the mold; and
C) subjecting the mold and contents of the mold to a first centrifugation and stopping after a first centrifugation length of time, thereby producing a first biosolidifying body; wherein waiting a first final biosolidification length of time following step C) produces a first biopolymer article from the first biosolidifying body.

3. The method of claim 2, wherein step A) includes settling the first biopolymer solution into the mold, wherein settling comprises subjecting the mold and the contents of the mold to a settling centrifugation and stopping after a settling centrifugation length of time, thereby conforming the first biopolymer solution to geometry of the mold.

4. (canceled)

5. The method of claim 3, wherein settling comprises tapping the mold and the contents of the mold on a surface, thereby conforming the first biopolymer solution to geometry of the mold.

6. (canceled)

7. The method of claim 2, wherein the first biopolymer solution is an aqueous silk solution, an aqueous alginate solution, an aqueous fibrinogen solution, an aqueous chitosan solution, an aqueous collagen solution, or a combination thereof.

8. The method of claim 2, the method further comprising the following sequential steps:
D) introducing a second biopolymer solution into the mold atop the first biosolidifying body and optionally settling the second biopolymer solution into the mold;
E) introducing a second curing solution into the mold atop the second biopolymer solution and optionally settling the second curing solution into the mold; and
F) subjecting the mold and contents of the mold to a second centrifugation and stopping after a second centrifugation length of time, thereby producing a second biosolidifying body inclusive of the first biosolidifying body,
wherein waiting a second final biosolidification length of time following step F) produces a second biopolymer article from the second biosolidifying body.

9. (canceled)

10. (canceled)

11. (canceled)

12. The method of claim 8, the method further comprising the following steps:
G) introducing a third biopolymer solution into the mold atop the second biosolidifying body and optionally settling the third biopolymer solution into the mold;
H) introducing a third curing solution into the mold atop the third biopolymer solution and optionally settling the third curing solution into the mold; and
I) subjecting the mold and contents of the mold to a third centrifugation and stopping after a third centrifugation length of time, thereby producing a third biosolidifying body inclusive of the first and second biosolidifying bodies,
wherein waiting a third final biosolidifcation length of time following step I) produces a third biopolymer article from the third biosolidifying body.

13-17. (canceled)

18. A method of making a biopolymer article, the method comprising at least two iterative cycles of the following steps:
X) introducing an iterative biopolymer solution into a mold and optionally settling the iterative biopolymer solution into the mold;
Y) introducing an iterative curing solution into the mold atop the iterative biopolymer solution and optionally settling the iterative curing solution into the mold; and
Z) subjecting the mold and the contents of the mold to an iterative centrifugation and stopping after an iterative centrifugal length of time, thereby iteratively adding to existing portions of a biosolidifying body, the iteratively introducing of step X), introducing of step Y), and subjecting of step Z) continuing until a final biosolidifying body is formed, wherein waiting a final biosolidification length of time following formation of the final biosolidification body produces the biopolymer article.

19-21. (canceled)

22. A controlled centrifugal solidification chitosan article, wherein the article is not a film, wherein at least a portion of the article comprises at least one characteristic centrifugal property selected from the group consisting of:
i) a uniform density across the at least a portion of the article;
ii) the at least a portion of the article is optically nontransparent;
iii) the at least a portion of the article is free of exterior layering;
iv) the at least a portion of the article is free of interior layering;
v) the at least a portion of the article is interior-void-free; and
vi) the at least a portion of the article is free of cylindrical extrusion gaps.

23-24. (canceled)

25. The method of claim 2, wherein the first biopolymer article comprises a monolith or whole or bulk construct.

26. The method of claim 2, wherein subjecting the mold and contents of the mold to a first centrifugation removes air bubbles from the first biosolidifying body.

27. The method of claim 2, wherein the method is performed at room temperature.

28. The method of claim 2, wherein the mold comprises more than one piece.

29. The method of claim 2, wherein a top mold is present during one or more centrifugation step, thereby introducing additional molding to one or more of the biosolidifying articles.

30. The method of claim 2, wherein the mold has a first orientation relative to gravity during step B) and the mold is within 45° of the first orientation during step C).

31. The method of claim 18, wherein settling the iterative biopolymer solution into the mold comprises subjecting the mold and the contents of the mold to a settling centrifugation and stopping after a settling centrifugation length of time, thereby conforming the iterative biopolymer solution to geometry of the mold.

32. The method of claim 18, wherein the mold comprises more than one piece.

33. The method of claim 18, wherein the mold has a top mold portion positioned atop the iterative curing solution and provides shaping to a top surface of the biosolidifying body or the biopolymer article.

34. The method of claim 18, wherein the mold is 3D printed.

35. The method of claim 18, wherein the iterative biopolymer solution is an aqueous silk solution, an aqueous alginate solution, an aqueous fibrinogen solution, an aqueous chitosan solution, an aqueous collagen solution, or a combination thereof.

36. The controlled centrifugal solidification chitosan article of claim 22, wherein the controlled centrifugal solidification chitosan article is substantially free of air bubbles.


SEQUENCE LISTING (22 sequences)

SEQ ID NO: 1 - protein, 90 aa, unidentified
  VARIANT 7..90: note = Any of resides 7 - 90 may be missing
GAGAGSGAGAGSGAGAGSGAGAGSGAGAGSGAGAGSGAGAGSGAGAGSGAGAGSGAGAGSGAGAGSGAGAGSGAGAGSGAGAGSGAGAGS

SEQ ID NO: 2 - protein, 30 aa, unidentified
  VARIANT 3..30: note = any of resides 3 - 30 may be missing
  VARIANT 2: note = wherein X=V, I, or A
  VARIANT 4: note = wherein X=V, I, or A
  VARIANT 6: note = wherein X=V, I, or A
  VARIANT 8: note = wherein X=V, I, or A
  VARIANT 10: note = wherein X=V, I, or A
  VARIANT 12: note = wherein X=V, I, or A
  VARIANT 14: note = wherein X=V, I, or A
  VARIANT 16: note = wherein X=V, I, or A
  VARIANT 18: note = wherein X=V, I, or A
  VARIANT 20: note = wherein X=V, I, or A
  VARIANT 22: note = wherein X=V, I, or A
  VARIANT 24: note = wherein X=V, I, or A
  VARIANT 26: note = wherein X=V, I, or A
  VARIANT 28: note = wherein X=V, I, or A
  VARIANT 30: note = wherein X=V, I, or A
GXGXGXGXGXGXGXGXGXGXGXGXGXGXGX

SEQ ID NO: 3 - protein, 4 aa, unidentified
GAAS

SEQ ID NO: 4 - protein, 15 aa, unidentified
  VARIANT 1..15: note = wherein one Serine residue may be missing
  VARIANT 1..15: note = wherein up to 2 Alanine residues may be missing
SSAAAAAAAAAAAAA

SEQ ID NO: 5-6 - skipped (2 entries)

SEQ ID NO: 7 - protein, 12 aa, unidentified
  VARIANT 2: note = wherein the serine residue may be missing
  VARIANT 8: note = wherein the serine residue may be missing
  VARIANT 4..12: note = wherein residues 4 - 12 may be missing
  VARIANT 4..6: note = wherein alanine residues may be missing
  VARIANT 10..12: note = wherein alanine residues may be missing
SSAAAASSAAAA

SEQ ID NO: 8 - protein, 6 aa, unidentified
GLGGLG

SEQ ID NO: 9 - protein, 6 aa, unidentified
  VARIANT 2: note = wherein X=L, I, V, P
  VARIANT 5: note = wherein X=L, I, V, P
GXGGXG

SEQ ID NO: 10 - protein, 15 aa, unidentified
  VARIANT 6..14: note = wherein residues 6 - 14 may be missing
  VARIANT 1..15: note = wherein the sequence can be repeated 'n' times
  VARIANT 5: note = wherein X=Y, V, S, A
  VARIANT 8: note = wherein X=Y, V, S, A
  VARIANT 11: note = wherein X=Y, V, S, A
  VARIANT 14: note = wherein X=Y, V, S, A
GPGGXGGXGGXGGXY

SEQ ID NO: 11 - protein, 5 aa, unidentified
  VARIANT 5: note = wherein the alanine residue may be repeated 'n' times
GRGGA

SEQ ID NO: 12 - protein, 13 aa, unidentified
  VARIANT 10: note = wherein the alanine residue may be missing
GAGAAAAAAAGGA

SEQ ID NO: 13 - protein, 8 aa, unidentified
  VARIANT 3: note = X=Q, Y, L, A, S, R
  VARIANT 5: note = X=Q, Y, L, A, S, R
  VARIANT 7: note = X=Q, Y, L, A, S, R
  VARIANT 8: note = X=Q, Y, L, A, S, R
GGXGXGXX

SEQ ID NO: 14 - protein, 16 aa, unidentified
TGSSGFGPYVNGGYSG

SEQ ID NO: 15 - protein, 8 aa, unidentified
YEYAWSSE

SEQ ID NO: 16 - protein, 7 aa, unidentified
SDFGTGS

SEQ ID NO: 17 - protein, 7 aa, unidentified
RRAGYDR

SEQ ID NO: 18 - protein, 8 aa, unidentified
EVIVIDDR

SEQ ID NO: 19 - protein, 17 aa, unidentified
TTHEDLDITIDGADGPI

SEQ ID NO: 20 - protein, 8 aa, unidentified
TISEELTI

SEQ ID NO: 21-22 - skipped (2 entries)